(19) United States
(12) Patent Application Publication
(10) Pub. No.: US 2026/0296535 A1
(43) Pub. Date: Oct. 1, 2026

(54) STEER-BY-WIRE VEHICLE STEERING CONTROL BASED ON CROSSING THROUGH CENTER OF A SPRING-TO-CENTER STEERING WHEEL

(71) Applicant: Ford Global Technologies, LLC, Dearborn, MI (US)

(72) Inventors: Bang Kim Cao, Northville, MI (US); Jonathan Craig Sullivan, Ferndale, MI (US); Matthew Meyerholtz Johnson, Toledo, OH (US); David Gon Oh, Canton, MI (US); Sage Aaron Stubbs, Livonia, MI (US)

(21) Appl. No.: 19/091,727

(22) Filed: Mar. 26, 2025

(51) Int. Cl. B62D 6/00; B62D 5/00; B62D 6/10

(52) U.S. Cl. CPC B62D 6/002; B62D 5/005; B62D 6/10

(57) ABSTRACT

An example steer-by-wire system includes: interface circuitry to obtain a steering wheel torque value corresponding to a torque applied to a spring-to-center steering wheel; machine-readable instructions; and at least one processor circuit to be programmed by the machine-readable instructions to at least: after the steering wheel torque value satisfies a threshold value, determine an output target steering wheel angle value based on a blending of a current input target simulated steering wheel angle value and a previous input target simulated steering wheel angle value; and control a road wheel actuator to turn a road wheel based on the output target steering wheel angle value.

### FIELD OF THE DISCLOSURE

This disclosure relates generally to steering systems and, more particularly, to steer-by-wire vehicle steering control based on crossing through center of a spring-to-center steering wheel.

### BACKGROUND

Vehicles include multiple subsystems to carry out various functions. A steering subsystem enables a vehicle operator to control the direction of movement of the vehicle. In a mechanical steering subsystem, a steering shaft extends from a steering wheel to a rack and pinion assembly or a steering box system between the two front wheels of the vehicle. As the vehicle operator turns or rotates the steering wheel, the rotational motion is transferred through the steering shaft and translated into a linear movement by the rack and pinion assembly or the steering box system. The linear movement controls a steering direction of the two front wheels.

### SUMMARY

An example steer-by-wire system includes interface circuitry to obtain a steering wheel torque value corresponding to a torque applied to a spring-to-center steering wheel, machine-readable instructions, and at least one processor circuit to be programmed by the machine-readable instructions to at least after the steering wheel torque value satisfies a threshold value, determine an output target steering wheel angle value based on a blending of a current input target simulated steering wheel angle value and a previous input target simulated steering wheel angle value, and control a road wheel actuator to turn a road wheel based on the output target steering wheel angle value.

An example non-transitory machine-readable medium includes machine-readable instructions to cause at least one processor circuit to at least access a steering wheel torque value corresponding to a torque applied to a spring-to-center steering wheel coupled to a spring-to-center steering shaft, after the steering wheel torque value satisfies a threshold value, determine an output target steering wheel angle value based on a blending of a current input target simulated steering wheel angle value and a previous input target simulated steering wheel angle value, and control a road wheel actuator to turn a road wheel based on the output target steering wheel angle value.

An example vehicle includes a spring-to-center steering shaft having a portion statically fixed to a structure, the structure to resist rotation of the portion of the spring-to-center steering shaft, a spring-to-center steering wheel coupled to an end of the spring-to-center steering shaft, the spring-to-center steering wheel rotationally restricted by a torsional rigidity of the spring-to-center steering shaft, and a controller to after a threshold value is satisfied by a steering wheel torque value corresponding to a torque applied to the spring-to-center steering wheel, determine an output target steering wheel angle value based on a blending of a current input target simulated steering wheel angle value and a previous input target simulated steering wheel angle value, and control a road wheel actuator to turn a road wheel based on the output target steering wheel angle value.

An example steer-by-wire system includes a spring-to-center steering shaft having a portion statically fixed to a structure, the structure to resist rotation of the portion of the spring-to-center steering shaft, a spring-to-center steering wheel coupled to an end of the spring-to-center steering shaft, the spring-to-center steering wheel rotationally restricted by a torsional rigidity of the spring-to-center steering shaft, and a torque sensor to measure a torque associated with the spring-to-center steering shaft, the torque based on a force applied to the spring-to-center steering wheel.

### BRIEF DESCRIPTION OF THE DRAWINGS

FIG. 1 is a perspective view of a vehicle in which an example center-crossing steer controller is implemented as part of a SBW system.

FIG. 2 is a system diagram of an example implementation of a SBW system including the center-crossing steer controller of FIG. 1.

FIG. 3 is an example spring-to-center steering wheel assembly including an example steering shaft and an example torque sensor to measure torque applied to the spring-to-center steering wheel.

FIG. 4A is another example spring-to-center steering wheel assembly to measure torque applied to the spring-to-center steering wheel.

FIG. 4B is an example shaftless spring-to-center steering wheel assembly to measure torque applied to the spring-to-center steering wheel.

FIG. 5 is a block diagram of an example implementation of the center-crossing steer controller of FIGS. 1 and 2.

FIG. 6 is an example center-crossing steering control diagram that may be used to implement the center-crossing steer controller of FIG. 5 to generate steer commands.

FIG. 7 is an example block diagram of the over-center monitor circuitry of FIG. 5 to implement the over-center monitoring process of FIG. 6.

FIG. 8 is an example torque response graph corresponding to a driver releasing a spring-to-center steering wheel.

FIG. 9 is an example torque response graph corresponding to a driver applying same-direction input steering wheel torque to a spring-to-center steering wheel.

FIG. 10 is an example torque response graph corresponding to a driver applying opposite-direction input steering wheel torque to a spring-to-center steering wheel.

FIG. 11 is a flowchart representative of example machine readable instructions and/or example operations that may be executed, instantiated, and/or performed by example programmable circuitry to implement the center-crossing steer controller of FIG. 5.

FIG. 12 is a block diagram of an example processing platform including programmable circuitry structured to execute, instantiate, and/or perform the example machine readable instructions and/or perform the example operations of FIG. 11 to implement the center-crossing steer controller of FIG. 5.

FIG. 13 is a block diagram of an example implementation of the programmable circuitry of FIG. 12.

FIG. 14 is a block diagram of another example implementation of the programmable circuitry of FIG. 12.

In general, the same reference numbers will be used throughout the drawing(s) and accompanying written description to refer to the same or like parts. The figures are not necessarily to scale.

### DETAILED DESCRIPTION

Steer-by-wire systems provide vehicle operating benefits such as variable gear ratios between a steering wheel rotation and a road wheel angle, new cabin designs and experiences, and quiet wheel capabilities for L2+/L3 driving modes of a vehicle's advanced driver-assistance system (ADAS). Quiet wheel is implemented by parking a steering wheel to prevent its rotation while a vehicle's ADAS assists a driver in steering the vehicle.

Examples disclosed herein include a spring-to-center steering wheel (e.g., a small-angle steering wheel) to determine a driver's intent related to vehicle steering and to provide feedback to the driver as the driver applies steering wheel torque input via the spring-to-center steering wheel. In examples disclosed herein, a vehicle's steering is controlled based on amounts of torque applied by a driver to a spring-to-center steering wheel. For example, the amount of torque applied by a driver's hands to the spring-to-center steering wheel is measured and processed to control the road wheel angles of the vehicle for steering operations. As used herein, a spring-to-center steering wheel is defined as a steering wheel (e.g., a handwheel of a vehicle) that resists rotation and is center-biased throughout a steering operation regardless of whether a vehicle is in motion or stationary and/or regardless of whether the SBW system is powered or not powered. The rotation-resistant characteristic causes the spring-to-center steering wheel to turn less than or equal to approximately 20~30 degrees in either left (e.g., counterclockwise) or right (e.g., clockwise) directions during vehicle steering while providing sufficient steering information to control turn angles of the road wheels of the vehicle through their full road wheel angle range. Alternatively, in other examples, the spring-to-center steering wheel may be implemented to turn more than approximately 20~30 degrees in counterclockwise or clockwise directions during vehicle steering.

In examples disclosed herein, a center position of a steering wheel is a rotational position in which the steering wheel is at a zero-degree angle of orientation relative to a rest or reset orientation. As such, the center-bias characteristic of a spring-to-center steering wheel causes the spring-to-center steering wheel to generate a constant counter-torque back towards a center position or zero-angle position in response to driver-applied torque on the spring-to-center steering wheel away from center. When a driver releases the spring-to-center steering wheel, the spring-to-center steering wheel springs, recoils, rebounds, or otherwise returns back to the center position, regardless of whether the vehicle is in motion or stationary. In some examples, this return-to-center motion can be dampened to create a smooth motion.

In examples disclosed herein, the rotation-resistant and center-bias characteristics create the spring-recoil or spring-rebound responses when a spring-to-center steering wheel is urged in the left or right directions by a driver. Such spring-recoil or spring-rebound responses provide steering feedback to the driver by resisting the driver's steering wheel torque input. This built-in steering feedback allows substantially eliminating or reducing motor-generated steering wheel feedback used in some SBW systems. Accordingly, electrical power consumption can be substantially reduced during steering operations while still providing steering feedback to the driver through the spring-recoil, or spring-rebound, characteristic of the spring-to-center steering wheel. In addition, the rotation-resistant and center-bias characteristics allow measuring driver input steering wheel torque to control steering of a vehicle. Example spring-to-center steering wheels disclosed herein also reduced complexity of a handwheel actuator and reduce hardware non-operational modes of a handwheel actuator due to reduced complexity. Example spring-to-center steering wheels disclosed herein also facilitate synchronizing an ADAS steering angle when transitioning from ADAS steering control to non-assisted steering control and the vehicle is in a turn maneuver.

In examples disclosed herein, a spring-to-center steering wheel is coupled to a rotationally-resistant structure (e.g., a steering shaft, one or more springs, etc.) of a vehicle. For example, the spring-to-center steering wheel may be coupled to a steering shaft in which the steering shaft is secured to prevent or resist its rotation. In such examples, any rotation of the steering shaft in the clockwise or counterclockwise directions is due to its torsional flexibility. However, the steering shaft continuously urges itself back to its center position, regardless of whether the vehicle is in motion or stationary. Accordingly, steering shafts of examples disclosed herein are spring-to-center steering shafts.

In some examples, to secure a spring-to-center steering wheel to prevent its rotation, a portion of a spring-to-center steering shaft (e.g., a shaft end opposite the steering wheel) is fixed to a structure in a non-rotatable state. This makes the spring-to-center steering wheel resistant to rotation based on a torsional rigidity of the spring-to-center steering shaft. In other examples, a portion of the spring-to-center steering shaft is coupled to springs that resist rotation of the steering shaft. In other examples, the steering shaft is omitted and the spring-to-center steering wheel is coupled to one or more springs (e.g., air spring(s), Belville washer spring(s), leaf spring(s), cam spring(s), and/or any other spring type) that resist rotation of the spring-to-center steering wheel. In any case, the rotation of the spring-to-center steering wheel is limited to small angles (e.g., approximately less than or equal to approximately 20~30-degree angles in counterclockwise or clockwise directions), as allowed by the torsional flex of the spring-to-center steering shaft, (or as allowed by a tension of a spring coupled to the spring-to-center steering shaft or coupled to the spring-to-center steering wheel). As such, the spring-to-center steering wheel resists rotation regardless of the amount of rotational torque applied by a driver through the steering wheel to steer the vehicle, regardless of the speed of the vehicle or whether the vehicle is in motion, and/or regardless of whether the SBW system is powered or not powered. In other examples, the torsional flex of the spring-to-center steering shaft may be selected to allow the spring-to-center steering wheel to be turned from center to greater than approximately 20~30 degrees in counterclockwise or clockwise directions. In examples disclosed herein, the fixed, rotation-resistant state of the spring-to-center steering wheel remains as such throughout operation or non-operation of the vehicle. Accordingly, in examples disclosed herein, steering control is based on the amount of clockwise or counter-clockwise torque applied by the driver on the steering wheel even if rotational angle displacement of the steering wheel is limited.

The rotation-resistant and center-bias characteristics of spring-to-center steering wheels disclosed herein are unlike prior, fully rotatable steering wheels. That is, unlike spring-to-center steering wheels disclosed herein that resist rotation as described above, a prior, fully rotatable steering wheel can rotate up to and beyond 360 degrees during steering events of a vehicle in response to rotational torque applied to the steering wheel by a driver. Example spring-to-center steering wheels disclosed herein are useful to transition between a vehicle's manual steering mode (e.g., a steering mode in which steering of a vehicle is completely based on human steering input) and the vehicle's driver-assistance mode (e.g., a steering mode in which the vehicle's ADAS assists with steering the vehicle through machine-generated commands). For example, with prior, fully rotatable steering wheels, when the vehicle is in manual steering mode, the rotatable steering wheel is free to rotate so that the driver's steering input applied to the steering wheel turns the steering wheel to control the vehicle's direction of travel. However, under some scenarios when the vehicle transitions to the driver-assistance mode, the rotatable steering wheel may be parked so that the steering wheel does not physically rotate while the vehicle's ADAS assists with control of the steering.

In prior, fully rotatable steering wheel systems, transitioning from the driver-assistance mode to the manual steering mode is a complex process due to needing to synchronize a rotational position of the steering wheel to an angle of the road wheels before full control is handed over to the driver. For example, in a driver-assistance mode, a vehicle's ADAS may be assisting with turning the road wheels to a particular road wheel angle having a corresponding steering wheel angle. However, if the steering wheel is parked at center (e.g., a zero-degree steering wheel angle) and the vehicle's road wheels are turned, the steering wheel angle does not match the road wheel angle. As such, in the scenario where the driver abruptly disables the ADAS (e.g., abruptly assumes full control over steering activities) and the rotatable steering wheel angle is not aligned with the road wheel angle, handing over full control to the driver for manual steering is subject to first aligning the steering wheel angle with the road wheel angle.

Implementing SBW systems using example spring-to-center steering wheels disclosed herein eliminates the process of synchronizing between steering wheel rotation position and road wheel angle because a spring-to-center steering wheel remains substantially near center regardless of whether a vehicle is in manual steering mode or driver-assistance mode. As such, a steering wheel angle does not need to be matched to a road wheel angle when transitioning between a driver-assistance mode and a manual steering mode. Implementing SBW systems using example spring-to-center steering wheels disclosed herein also allows implementing buttons, switches, screens, etc. on the steering wheel because a spring-to-center steering wheel can be implemented with fewer components in the steering wheel than used in prior, fully rotatable steering wheels. In addition, example spring-to-center steering wheels disclosed herein do not require clockspring/rotary contact for electrical connections and enable steering wheel-mounted displays to maintain a generally stable orientation for driver viewing.

Examples disclosed herein implement an example crossing-center detection strategy in a SBW system based on a spring-to-center steering wheel. Such crossing-center detection strategy can be used to determine a driver's intent related to vehicle steering and to provide feedback to the driver as the spring-to-center steering wheel crosses through a center position. For example, the crossing-center detection strategy can be used to distinguish between a situation in which a driver releases torque on the spring-to-center steering wheel and the spring-to-center steering wheel freely returns to the center position and a situation in which a driver is applying torque on the spring-to-center steering wheel in one direction (e.g., a counterclockwise direction) and changes direction to apply torque in the opposite direction (e.g., a clockwise direction), causing the spring-to-center steering wheel to cross the center position based on the driver input torque. In both situations, the spring-to-center steering wheel crosses the center position. However, in the first situation, the crossing of the center position is due to oscillation from the free movement of the spring-to-center steering wheel rebounding back to the center position. In the second situation, the crossing of the center position is due to the driver input torque. Examples disclosed herein distinguish between both situations based on steering wheel torque to implement corresponding steering control actions of a vehicle. Accordingly, examples disclosed herein may be used to implement torque-based steering control based on a crossing-center strategy associated with rotation-limited spring-to-center steering wheels.

In examples disclosed herein, spring-to-center steering wheels have a stiffness, damping, and wheel inertia that, when released from a certain torque/angle, will have some free-movement oscillatory behavior as they release stored energy. Examples disclosed herein blend steering control from a default damping (e.g., dashpot) behavior (e.g., mimicking caster steering return to center) when the spring-to-center steering wheel is released, to an active steering strategy when it has been determined that the spring-to-center steering wheel has crossed through center beyond a threshold that could be reached by the free-movement oscillation. Examples disclosed herein monitor a steering wheel torque signal in a monitoring window having a duration based on the stiffness and inertia of the spring-to-center steering wheel. A change in steering wheel torque within this window is analyzed relative to a look up table having threshold values based on the inertia, stiffness, and damping of the spring-to-center steering wheel. When the steering wheel torque has exceeded a threshold in the opposite direction of a previous torque applied to the spring-to-center steering wheel, the steering wheel is considered to have crossed through center. After a determination that the spring-to-center steering wheel has crossed through center, a steering control blend routine is performed to transition steering control between a free-movement return to center routine and an active steering through center routine that uses a torque-to-steering wheel angle (SWA) lookup table. This steering control blend routine is based on the magnitude of driver input steering wheel torque applied in the opposite direction of a previously applied driver input steering wheel torque. Examples disclosed herein use different blend rates to implement the steering control blend routine. For example, the blend rate can be low at low driver input steering wheel torques and high at high driver input steering wheel torques. This adjusting of the blend rate allows for rapid counter-steering capabilities based on example spring-to-center steering wheels disclosed herein.

Examples disclosed herein allow vehicle steering control based on smaller driver input steering wheel torque at highway speeds to create SWAs and have a vehicle naturally follow caster back to a zero SWA. In examples disclosed herein, caster refers to a force exerted on road wheels to return back to a zero-degree road wheel angle and travel along a straight path due to suspension geometry and/or tire effects. Naturally following caster allows for light driver input steering wheel torque with inherent dwell to change the vehicle path of travel without having to hold a steering wheel angle or having to time how long the steering wheel angle is held. This allows use of a spring-to-center steering wheel in a way that more closely resembles the feel of letting a prior, fully rotatable steering wheel slide through the driver's hands as caster returns the vehicle to center. Examples disclosed herein handle the case where a driver has let go of a spring-to-center steering wheel and then decides to steer in the opposite direction, selecting a SWA rate that is faster than caster would naturally return the spring-to-center steering wheel to center.

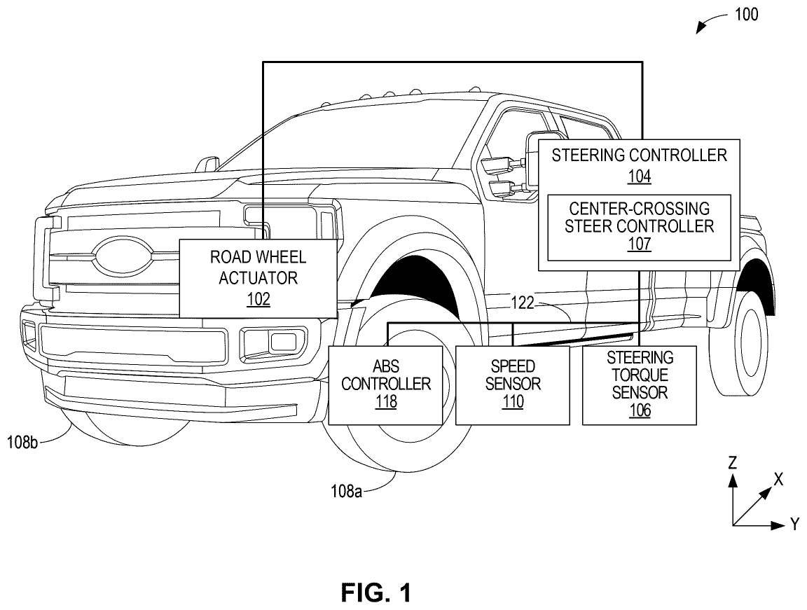

FIG. 1 is a perspective view of an example vehicle 100 in which examples disclosed herein can be implemented. In the illustrated example of FIG. 1, the vehicle 100 includes an example road wheel actuator 102, an example steering controller 104, and an example steering torque sensor 106. Also in the illustrated example, the steering controller 104 includes an example center-crossing steer controller 107. The vehicle 100 is a wheel-driven vehicle. In the illustrated example of FIG. 1, the vehicle 100 is a pick-up truck. In other examples, the vehicle 100 can be any type of wheeled vehicle (e.g., a sedan, a coupe, a van, a sports utility vehicle, an all-terrain vehicle (ATV), farming equipment, etc.). In some examples, the vehicle 100 includes an internal combustion engine (e.g., a non-electrified vehicle, a partially electrified vehicle, etc.). In other examples, the vehicle 100 is a fully electric vehicle.

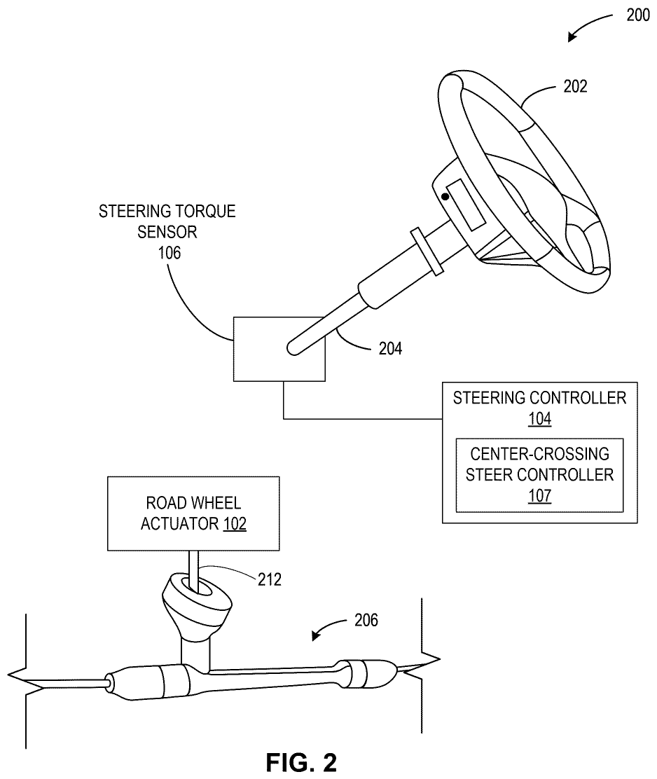

In the example of FIG. 1, the road wheel actuator 102 and the steering controller 104 implement a SBW system (e.g., the SBW system 200 of FIG. 2). One or both of the road wheel actuator 102 and the steering controller 104 may be implemented as programmable circuitry. The road wheel actuator 102 allows a user of the vehicle 100 to control/steer front road wheels 108a, b of the vehicle 100. In other examples, the road wheel actuator 102 (and/or a separate road wheel actuator) allows a user of a vehicle 100 to also control/steer rear wheels of a four-wheel steer vehicle 100. In the illustrated example of FIG. 1, the road wheel actuator 102 and the steering controller 104 include corresponding communication interfaces (e.g., wired or wireless interfaces) to communicate control information and feedback between the road wheel actuator 102 and the steering controller 104.

The steering controller 104 controls and/or manages the road wheel actuator 102. For example, the steering controller 104 can calculate a rotational angle of the road wheel actuator 102 based on driver input applied to a steering wheel (e.g., the spring-to-center steering wheel 202 of FIG. 2). In some examples, some or all of the steering controller 104 can be implemented by an electronic control unit (ECU) of the vehicle 100. In other examples, the steering controller 104 can be implemented by another suitable computer (e.g., another computer of the vehicle 100, a mobile device of a user of the vehicle 100, a remote computer, etc.).

The steering controller 104 is in circuit with the steering torque sensor 106. For example, the steering torque sensor 106 is provided to measure an amount of input steering wheel torque applied by a driver to a spring-to-center steering wheel (e.g., the spring-to-center steering wheel 202 of FIG. 2) of the vehicle 100. The steering torque sensor 106 provides the measured input steering wheel torque value to the steering controller 104. The center-crossing steer controller 107 is provided to use the input steering wheel torque value to generate steering commands that instruct the road wheel actuator 102 how to steer the road wheels 108a, b so that the vehicle 100 travels along a path intended by the driver. Although the center-crossing steer controller 107 is shown as implemented in the steering controller 104, the center-crossing steer controller 107 can alternatively be implemented in the road wheel actuator 102. In such examples, the center-crossing steer controller 107 can receive steering wheel torque values from the steering controller 104 based on measured torque values from the steering torque sensor 106.

In the example of FIG. 1, the vehicle 100 is also provided with an example speed sensor 110 and an example anti-lock braking system (ABS) controller 118. In the example of FIG. 1, the steering torque sensor 106, the speed sensor 110, and the ABS controller 118 are communicatively coupled with the steering controller 104 and/or the center-crossing steer controller 107 via a controller area network (CAN) bus 122. In other examples, the CAN bus 122 may alternatively be implemented using any other suitable type of wired and/or wireless communication system (e.g., a Local Interconnect Network (LIN) bus interface, a Media Oriented Systems Transport (MOST) bus interface, an Automotive Ethernet bus interface, etc.). In examples in which the center-crossing steer controller 107 is implemented in the road wheel actuator 102, the center-crossing steer controller 107 can receive measurement data associated with the steering torque sensor 106, the speed sensor 110, and the ABS controller 118 from the steering controller 104. Alternatively, the steering torque sensor 106, the speed sensor 110, and the ABS controller 118 are communicatively coupled with the road wheel actuator 102 and/or the center-crossing steer controller 107 in the road wheel actuator 102 via the CAN bus 122. In some examples, the steering torque sensor 106, the speed sensor 110, and/or the ABS controller 118 convert sensor signals into measured values to directly generate corresponding measured parameter values. In other examples, the steering torque sensor 106, the speed sensor 110, and/or the ABS controller 118 calculate estimated parameter values based on sensor data to generate corresponding measured parameter values.

The speed sensor 110 is provided to measure a road wheel speed of the vehicle 100. The ABS controller 118 is provided to assist with wheel braking and to measure speed and acceleration/deceleration of the road wheels of the vehicle 100. In some examples, the speed sensor 110 can be omitted and speed values can be obtained based on measurement values (e.g., speed measures) from the ABS controller 118. Alternatively, the measurement values from the ABS controller 118 can be used in combination with the speed sensor 110 to determine road wheel speed values.

FIG. 2 is a system diagram of an example SBW system 200 that includes the road wheel actuator 102, the steering controller 104, the steering torque sensor 106, and the center-crossing steer controller 107 of FIG. 1. The SBW system 200 also includes an example spring-to-center steering wheel 202, an example spring-to-center steering shaft 204, and an example rack and pinion system 206. The rack and pinion system 206 is coupled to the front road wheels 108a, b of the vehicle 100 (FIG. 1). In other examples, the rack and pinion system 206 (or a rack and pinion system similar to the rack and pinion system 206) is coupled to the rear wheels of a four-wheel steer vehicle 100. In the example of FIG. 2, the steering controller 104, the steering torque sensor 106, and the center-crossing steer controller 107 implement a handwheel actuator (HWA) subsystem of the SBW system 200.

The spring-to-center steering wheel 202 is coupled to the spring-to-center steering shaft 204 and allows a user of the vehicle 100 to operate the road wheel actuator 102 and thereby steer the vehicle 100. To do so, the steering controller 104 is in communication with the road wheel actuator 102. For example, the steering controller 104 includes a transceiver (e.g., a wireless or wired transceiver) that is in communication with a transceiver (e.g., a wireless or wired transceiver) of the road wheel actuator 102. As such, the steering controller 104 can use driver inputs (e.g., driver-input steering wheel torque) applied to the spring-to-center steering wheel 202 to generate and transmit steering control signals (e.g., steering commands) to the road wheel actuator 102. In addition, the steering controller 104 can receive vehicle handling feedback from the road wheel actuator 102. The spring-to-center steering wheel 202 includes an interface (e.g., handgrips, etc.) that enables a user to apply torque to the spring-to-center steering shaft 204 that is measured as driver input by the steering torque sensor 106. For example, as the user turns the spring-to-center steering wheel 202, the rotational torque of the spring-to-center steering wheel 202 is transferred through the spring-to-center steering shaft 204 to the steering torque sensor 106.

The rack and pinion system 206 is a linear actuator that includes a pinion engaged with a rack. The road wheel actuator 102 is coupled to the rack and pinion system 206 via an example wheel-steering shaft 212 to receive rotational inputs from the road wheel actuator 102 via the wheel-steering shaft 212. The rack and pinion system 206 translates the rotational inputs from the road wheel actuator 102 into linear motion to steer the road wheels 108a, b. In this manner, a user operating the spring-to-center steering wheel 202 causes the rack and pinion system 206 to change directions of the vehicle 100 by steering the road wheels 108a, b. Alternatively, instead of the rack and pinion system 206, the vehicle 100 may be provided with a steering box system, a recirculating ball/pitman arm steering system, or any other suitable type of road wheel steering system (e.g., any type of road wheel steering system that translates between rotational motion and linear motion), and examples disclosed herein may be adapted to operate with such steering system.

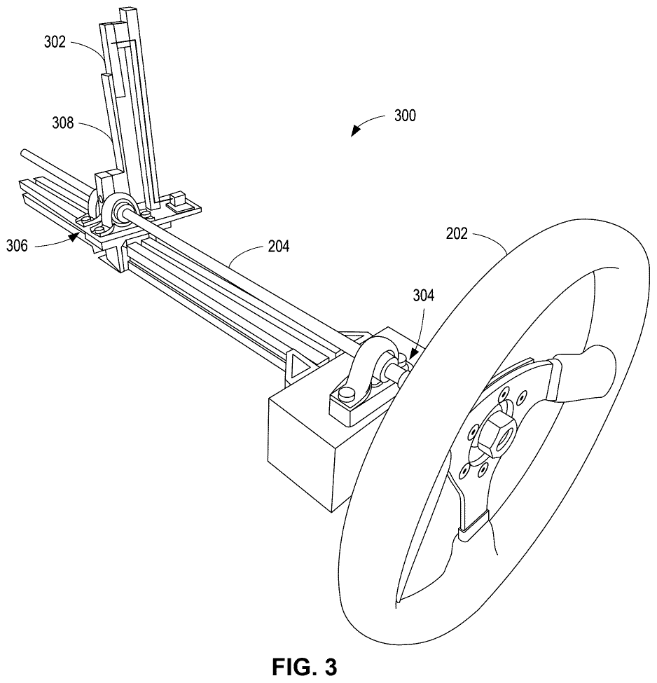

FIG. 3 is an example spring-to-center steering wheel assembly 300 including the example spring-to-center steering shaft 204 and an example torque sensor 302 to measure torque applied to the spring-to-center steering wheel 202. The torque sensor 302 may implement the steering torque sensor 106 of FIGS. 1 and 2. In the example of FIG. 3, the spring-to-center steering wheel 202 is coupled to an example steering wheel shaft end 304 of the spring-to-center steering shaft 204 in the vehicle 100. The spring-to-center steering shaft 204 has a fixed shaft portion 306 that is statically fixed to an example torque arm 308. In the example of FIG. 3, the torque arm 308 transfers torque from the spring-to-center steering shaft 204 to the torque sensor 302. The torque arm 308 is rigid in that it is resistant to bending and resists rotation of the fixed shaft portion 306 of the spring-to-center steering shaft 204. The spring-to-center steering wheel 202 is rotationally restricted by a torsional rigidity of the spring-to-center steering shaft 204. That is, while the torque arm 308 resists rotation of the fixed shaft portion 306, the torsional rigidity of the spring-to-center steering shaft 204 resists twisting of the spring-to-center steering shaft 204 between the fixed shaft portion 306 and the steering wheel shaft end 304 when driver input steering wheel torque is applied to the spring-to-center steering wheel 202.

In the example of FIG. 3, the torque sensor 302 is a cantilever load cell and the torque arm 308 spans between the fixed shaft portion 306 and the torque sensor 302. When implemented using a cantilever load cell, the torque sensor 302 detects the amount of clockwise or counterclockwise torque exerted on the spring-to-center steering shaft 204 by a rotational force on the spring-to-center steering wheel 202. For example, in response to the rotational force on the spring-to-center steering wheel 202, the fixed shaft portion 306 exerts a rotational force through the torque arm 308 to the torque sensor 302. Accordingly, the torque arm 308 deflects the torque sensor 302 and the torque sensor 302 senses the torque from the spring-to-center steering wheel 202 based on the force transferred through the torque arm 308 to the torque sensor 302. The torque sensor 302 generates a torque measurement signal representative of the detected clockwise or counterclockwise torque. The torque sensor 302 provides the torque measurement signal to the steering controller 104 for use by the center-crossing steer controller 107 to generate a corresponding steering command.

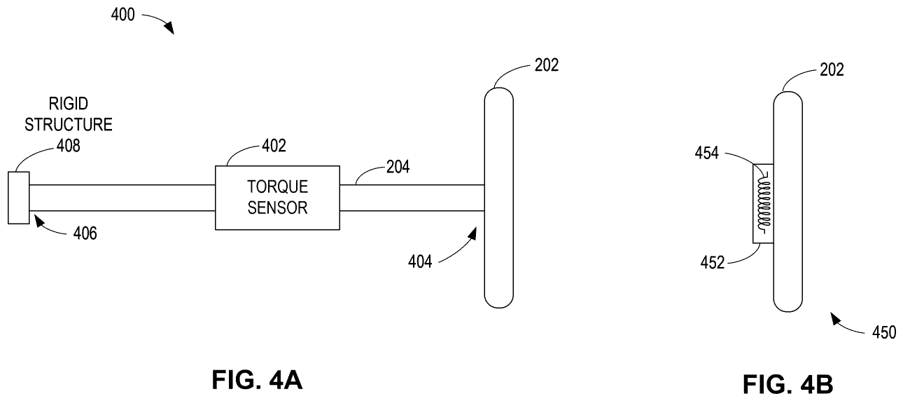

FIG. 4A is another example spring-to-center steering wheel assembly 400 to measure clockwise and counterclockwise torques applied to the spring-to-center steering wheel 202. In the example of FIG. 4A, the spring-to-center steering wheel assembly 400 includes an example torque sensor 402 to measure torque applied to the spring-to-center steering wheel 202. The torque sensor 402 may implement the steering torque sensor 106 of FIGS. 1 and 2. The spring-to-center steering wheel 202 is coupled to an example steering wheel shaft end 404 of the spring-to-center steering shaft 204 and the spring-to-center steering shaft 204 has an example fixed shaft portion 406 that is statically fixed to an example rigid structure 408. The rigid structure 408 prevents rotation of the fixed shaft portion 406 of the spring-to-center steering shaft 204 so that a torsional flexibility of the spring-to-center steering shaft 204 allows a twisting of the spring-to-center steering shaft 204 commensurate with the amount of torsional force applied by a driver on the spring-to-center steering wheel 202. The rigid structure 408 may be any fixed structure of the vehicle 100 that prevents rotation of the fixed shaft portion 406.

In the example of FIG. 4A, the torque sensor 402 is positioned on the spring-to-center steering shaft 204 between the steering wheel shaft end 404 and the fixed shaft portion 406. Torsional elasticity of the spring-to-center steering shaft 204 causes the spring-to-center steering shaft 204 to twist between the steering wheel shaft end 404 and the fixed shaft portion 406 in response to torsional force applied on the spring-to-center steering wheel 202 while simultaneously transferring torque from the spring-to-center steering wheel 202 to the torque sensor 402. As torque is transferred from the spring-to-center steering wheel 202 to the spring-to-center steering shaft 204, the torque sensor 402 generates a torque measurement signal representative of the detected clockwise or counterclockwise torque and provides the torque measurement signal to the steering controller 104. The center-crossing steer controller 107 uses the torque measurement to generate a corresponding steering command.

In some examples, the torque sensor 402 is implemented using a shaft torque sensor such as a rotary torque sensor. In such examples, the shaft torque sensor senses the torque transferred from the spring-to-center steering wheel 202 to the spring-to-center steering shaft 204 and generates a torque measurement signal representative of the detected clockwise or counterclockwise torque. In other examples, the torque sensor 402 is implemented using a strain gauge fixed to a surface of the spring-to-center steering shaft 204.

In yet other examples, the torque sensor 402 is implemented using an encoder (e.g., a rotary encoder, an optical encoder, etc.) in combination with logic circuitry that converts a measured rotational travel (e.g., a twist angle) provided by the encoder to a rotational torque measurement. In yet other examples, the torque sensor 402 is implemented using a geared angle sensor in combination with logic circuitry that converts a measured rotational angle displacement value provided by the geared angle sensor to a rotational torque measurement value. In such examples, the measured rotational travel provided by the encoder or the measured rotational angle displacement provided by the geared angle sensor are a twist angle of the spring-to-center steering shaft 204. The twist angle is representative of an amount of torsional twist between the steering wheel shaft end 404 and the fixed shaft portion 406 based on steering wheel torque produced via the spring-to-center steering wheel 202. The twist angle can be converted to a torque measure based on, for example, a value of torsional rigidity (e.g., a known stiffness) of the spring-to-center steering shaft 204.

FIG. 4B is an example shaftless spring-to-center steering wheel assembly 450 to measure torque applied to the spring-to-center steering wheel 202. The shaftless spring-to-center steering wheel assembly 450 includes an example torque sensor 452. The torque sensor 452 may implement the steering torque sensor 106 of FIGS. 1 and 2. The spring-to-center steering wheel 202 is mounted to the torque sensor 452 so that the torque sensor 452 can measure an amount of steering wheel torque exerted on the spring-to-center steering wheel 202. In the example of FIG. 4B, the torque sensor 452 includes or is co-located with one or more example springs 454. The example springs 454 are coupled to the spring-to-center steering wheel 202 to resist rotational movement of the spring-to-center steering wheel 202 and to center-bias the spring-to-center steering wheel 202. As such, examples disclosed herein may be implemented without a steering shaft (e.g., the spring-to-center steering shaft 204) while still providing substantially similar characteristics to operation of the spring-to-center steering wheel 202 as provided by the spring-to-center steering shaft 204.

The example spring-to-center steering wheel assemblies 300, 400, 450 of FIGS. 3, 4A, and 4B are provided as mere examples. Any other suitable spring-to-center steering wheel assembly configurations may be used to implement the spring-to-center steering wheel 202. In addition, any other suitable type of sensor and/or sensor configuration may be used to implement the torque sensors 106, 302, 402, and/or 452.

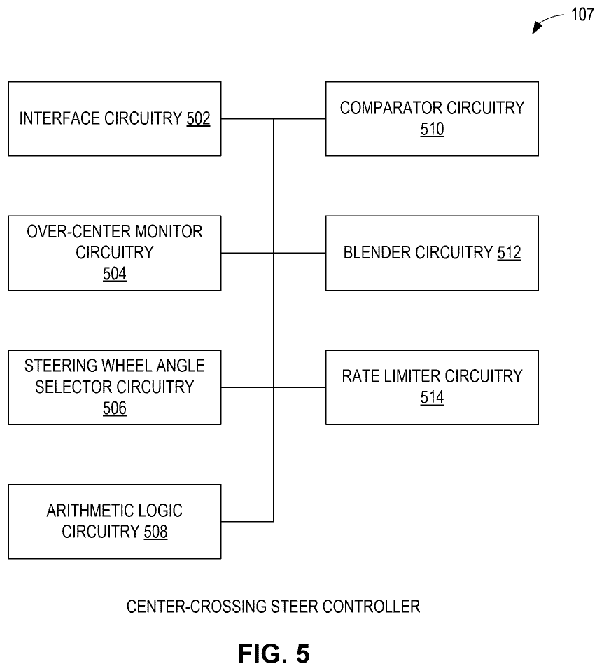

FIG. 5 is a block diagram of an example implementation of the center-crossing steer controller 107 of FIGS. 1 and 2 to generate steer commands based on the spring-to-center steering wheel 202 of FIGS. 2, 3, 4A, and 4B. The center-crossing steer controller 107 of FIG. 5 may be instantiated (e.g., creating an instance of, bring into being for any length of time, materialize, implement, etc.) by programmable circuitry such as a Central Processor Unit (CPU) executing first instructions. Additionally or alternatively, the center-crossing steer controller 107 of FIG. 5 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 5 may, thus, be instantiated at the same or different times. Some or all of the circuitry of FIG. 5 may be instantiated, for example, in one or more threads executing concurrently on hardware and/or in series on hardware. Moreover, in some examples, some or all of the circuitry of FIG. 5 may be implemented by microprocessor circuitry executing instructions and/or FPGA circuitry performing operations to implement one or more virtual machines and/or containers.

In the example of FIG. 5, the center-crossing steer controller 107 includes example interface circuitry 502, example over-center monitor circuitry 504, example steering wheel angle selector circuitry 506, example arithmetic logic circuitry 508, example comparator circuitry 510, example blender circuitry 512, and example rate limiter circuitry 514. The interface circuitry 502 is provided to access sensor measurement signals and/or sensor measurement values from one or more sensors in the vehicle 100. For example, the interface circuitry 502 may access torque measurement values generated based on torque measurement signals from the steering torque sensor 106. The interface circuitry 502 may also access road wheel speed values from the speed sensor 110. In some examples, the interface circuitry 502 is communicatively coupled to the ABS controller 118 and receives road wheel speed measurement values from the ABS controller 118.

The over-center monitor circuitry 504 is provided to determine when the spring-to-center steering wheel 202 crosses a center position. The steering wheel angle selector circuitry 506 is provided to select steering wheel angles based on steering wheel torque applied to the spring-to-center steering wheel 202. The arithmetic logic circuitry 508 is provided to perform mathematical and/or logic processes. The comparator circuitry 510 is provided to compare values. For example, the comparator circuitry 510 may compare input steering wheel torque values to threshold torque values to detect center crossings of the spring-to-center steering wheel 202.

The blender circuitry 512 is provided to blend steering control from a default damping behavior (e.g., mimicking caster steering return to center) when the spring-to-center steering wheel 202 is released and is freely moving back to center, to an active steering strategy when the spring-to-center steering wheel 202 is moved by a driver in a direction (e.g., clockwise) opposite a previously applied torque (e.g., counterclockwise) and has crossed through center beyond a threshold that could be reached by free-movement oscillation.

The rate limiter circuitry 514 is provided to limit steer commands to reflect steering wheel rotation rates that are physically possible with a prior, fully rotatable steering wheel. For example, a driver input steering wheel torque applied to the spring-to-center steering wheel 202 is translated to a road wheel angle. However, to prevent an abrupt road wheel angle change, the rate limiter circuitry 514 applies a slew rate limit when applying the calculated road wheel angle at the road wheel actuator 102. As such, the rate limiter circuitry 514 controls how quickly the road wheel actuator 102 adjusts the road wheel angle of the road wheels 108a, b. To do so, the rate limiter circuitry 514 can decrease a road wheel angle represented in a steer command by replacing the road wheel angle value in the steer command with a smaller road wheel angle value.

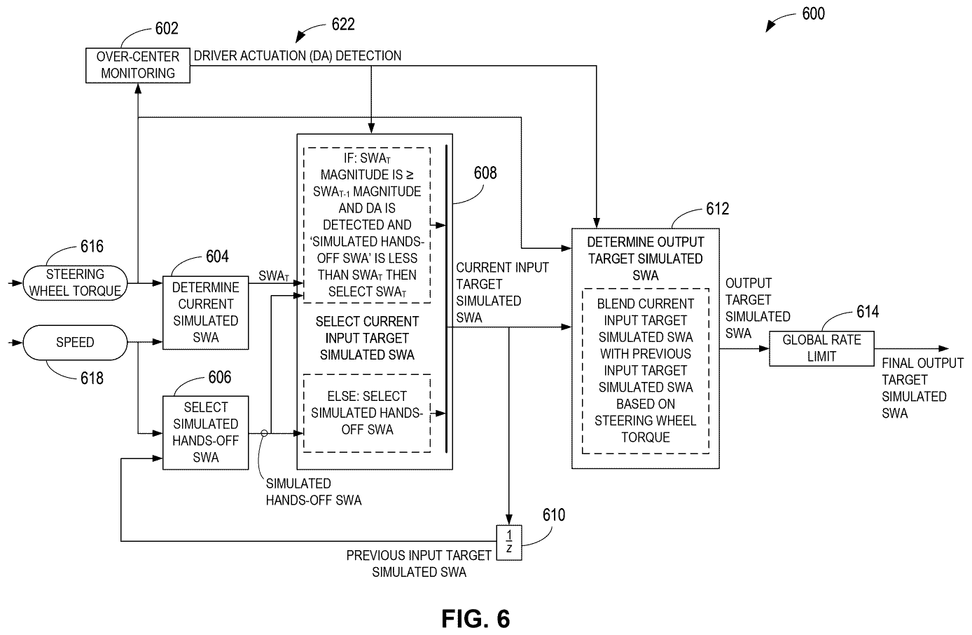

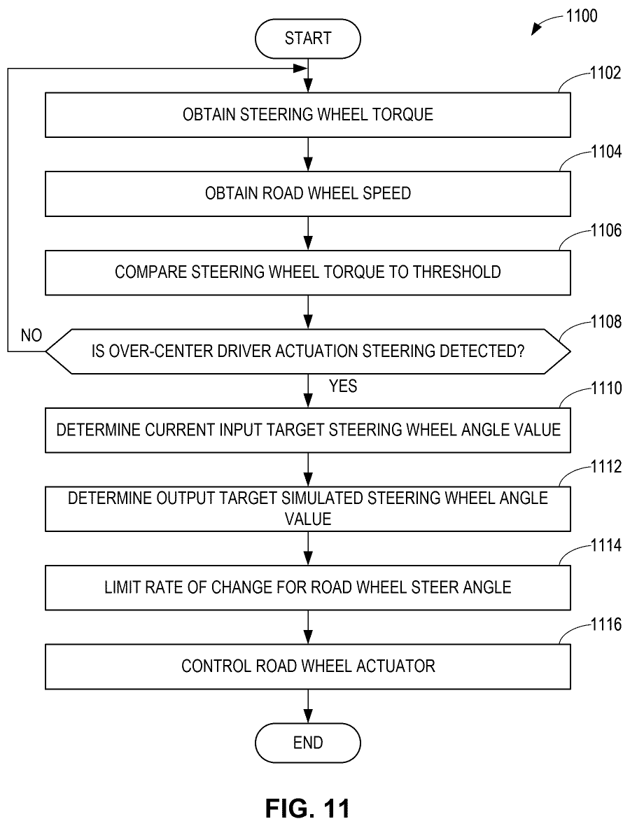

In some examples, the interface circuitry 502, the over-center monitor circuitry 504, the steering wheel angle selector circuitry 506, the arithmetic logic circuitry 508, the comparator circuitry 510, the blender circuitry 512, and the rate limiter circuitry 514 are instantiated by programmable circuitry executing instructions and/or configured to perform operations such as those represented by one or more of the control diagram of FIG. 6 and/or the flowchart of FIG. 11.

As described above, the interface circuitry 502, the over-center monitor circuitry 504, the steering wheel angle selector circuitry 506, the arithmetic logic circuitry 508, the comparator circuitry 510, the blender circuitry 512, and the rate limiter circuitry 514 of FIG. 5 are structures. Such structures may implement means for performing corresponding disclosed functions. Examples of such functions are described above in connection with corresponding ones of the interface circuitry 502, the over-center monitor circuitry 504, the steering wheel angle selector circuitry 506, the arithmetic logic circuitry 508, the comparator circuitry 510, the blender circuitry 512, and the rate limiter circuitry 514 and are described below in connection with the control diagram of FIG. 6 and the flowchart of FIG. 11.

While an example manner of implementing the center-crossing steer controller 107 of FIG. 1 is illustrated in FIG. 5, one or more of the elements, processes, and/or devices illustrated in FIG. 5 may be combined, divided, re-arranged, omitted, eliminated, and/or implemented in any other way. Further, the interface circuitry 502, the over-center monitor circuitry 504, the steering wheel angle selector circuitry 506, the arithmetic logic circuitry 508, the comparator circuitry 510, the blender circuitry 512, and the rate limiter circuitry 514, and/or, more generally, the example center-crossing steer controller 107 of FIG. 5, may be implemented by hardware alone or by hardware in combination with software and/or firmware. Thus, for example, any of the interface circuitry 502, the over-center monitor circuitry 504, the steering wheel angle selector circuitry 506, the arithmetic logic circuitry 508, the comparator circuitry 510, the blender circuitry 512, and the rate limiter circuitry 514, and/or, more generally, the example center-crossing steer controller 107, could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example center-crossing steer controller 107 of FIG. 5 may include one or more elements, processes, and/or devices in addition to, or instead of, those illustrated in FIG. 5, and/or may include more than one of any or all of the illustrated elements, processes and devices.

FIG. 6 is an example center-crossing steering control diagram of steer control instructions and/or operations 600 that may be used to implement the center-crossing steer controller 107 of FIG. 5 to generate steer commands. The steer control instructions and/or operations 600 include an example over-center monitoring process 602, an example ‘current simulated SWA’ determination process 604, an example ‘simulated hands-off SWA’ selection process 606, an example ‘current input target simulated SWA’ selection process 608, an example one-loop delay 610, an example ‘output target simulated SWA’ determination process 612, and an example global rate limit process 614. The steer control instructions and/or operations 600 are performed repeatedly during a driving session as part of SBW steering control for the vehicle 100. Each iteration of the steer control instructions and/or operations 600 produces a target SWA to be used in a steer command. The center-crossing steer controller 107 can then send the steer command to the road wheel actuator 102 to cause the road wheel actuator 102 to actuate the rack and pinion system 206 to turn the road wheels 108a, b. As described in detail below, subsequent iterations of the steer control instructions and/or operations 600 generate current SWA values of time T (SWA_{T}) based on previous SWA values of time T-1 (SWA_{T-1}) corresponding to previous iterations.

As described above, spring-to-center steering wheels (e.g., the spring-to-center steering wheel 202) disclosed herein have limited rotation. As such, the spring-to-center steering wheels do not produce the full range of rotation of prior, fully rotatable steering wheels. To adapt the limited rotation of the spring-to-center steering wheel 202 to work in the SBW system 200 of FIG. 2, the steer control instructions and/or operations 600 translate steering wheel torque values from the steering torque sensor 106 associated with the spring-to-center steering wheel 202 to simulated SWAs. In examples disclosed herein, a simulated SWA is an estimate of a SWA of a prior, fully rotatable steering wheel. Such translations are performed to assist in the SBW steering control based on SWAs even though the spring-to-center steering wheel 202 has limited rotation as described above.

In the example of FIG. 6, steering wheel torque values 616 and road wheel speed values 618 (e.g., vehicle speeds) are obtained. For example, the interface circuitry 502 (FIG. 2) may obtain the steering wheel torque values 616 from the steering torque sensor 106 (FIGS. 1 and 2). In addition, the interface circuitry 502 may obtain the road wheel speed values 618 from the speed sensor 110 and/or from the ABS controller 118 of FIG. 1. In some examples, the interface circuitry 502 receives sensor signals from the steering torque sensor 106, the speed sensor 110, and/or from the ABS controller 118 and determines the steering wheel torque values 616 and the road wheel speed values 618 based on corresponding ones of the sensor signals.

At the over-center monitoring process 602, the over-center monitor circuitry 504 defines a window of time based on a filter constant selected to retain low frequency content and, thus, capture and retain maximum steering torque values while high-frequency oscillations are occurring when the spring-to-center steering wheel 202 is released. The over-center monitor circuitry 504 performs a peak detection analysis on the steering wheel torque values 616 received during that window of time. The duration of the window of time is selected so that a detected maximum steering wheel torque to the left (e.g., a counterclockwise direction) or a detected maximum steering wheel torque to the right (e.g., a clockwise direction) can be used to analyze subsequent measured torque values corresponding to free-movement oscillation of the spring-to-center steering wheel 202 after being released by a driver. Accordingly, by selecting the duration of the window of time to span between the detected maximum steering wheel torque and a return-to-center of the spring-to-center steering wheel 202, the window of time can be used to determine when a driver has reached a maximum steering wheel torque to the right (e.g., a clockwise direction) or to the left (e.g., a counterclockwise direction) and has released the spring-to-center steering wheel 202 to revert the road wheels 108a, b of the vehicle 100 to travel along a straight path. In some examples, the duration of the window of time is selected based on how long the spring-to-center steering wheel 202 typically oscillates during free movement after being released by a driver. Such free-movement oscillation duration is based on a torsional rigidity (e.g., a known stiffness) of the spring-to-center steering shaft 204 and/or a typical inertia of the spring-to-center steering wheel 202 when released by the driver.

The over-center monitor circuitry 504 performs the peak detection analysis to identify a highest one of the steering wheel torque values 616 (e.g., a local maximum torque value) in the window of time. The over-center monitor circuitry 504 maps the detected maximum steering wheel torque value to a minimum threshold torque value that is to be satisfied in a direction opposite the direction of the identified maximum steering wheel torque value. Accordingly, the over-center monitor circuitry 504 can determine when a steering wheel torque value 616 exceeds the minimum threshold torque value in a first direction, the first direction opposite a second direction in which a previous steering wheel torque value 616 was applied by a driver to the spring-to-center steering wheel 202. For example, if the detected maximum steering wheel torque value applied by a driver corresponds to counterclockwise torque on the spring-to-center steering wheel 202, the mapped minimum threshold torque value corresponds to clockwise torque. In examples disclosed herein, the minimum threshold torque value represents a torque that cannot be imparted on the spring-to-center steering wheel 202 by free-movement oscillation after a driver releases the spring-to-center steering wheel 202. However, the torque represented by the minimum threshold torque value can be imparted on the spring-to-center steering wheel 202 by a driver actively applying torque on the spring-to-center steering wheel 202 in the direction that is opposite the direction of the detected maximum steering wheel torque value.

In some examples, the minimum threshold torque values are based on the amount of initial torque applied by the driver on the spring-to-center steering wheel 202 before releasing the spring-to-center steering wheel 202 to return to center, the torsional rigidity (e.g., a known stiffness) of the spring-to-center steering shaft 204, and/or the typical inertia of the spring-to-center steering wheel 202. For example, the torsional rigidity and the inertia characteristics can be used to calculate a maximum free-movement oscillation torque of the spring-to-center steering wheel 202 in a second direction after being released from a particular torque applied by the driver on the spring-to-center steering wheel 202 in a first direction opposite the second direction.

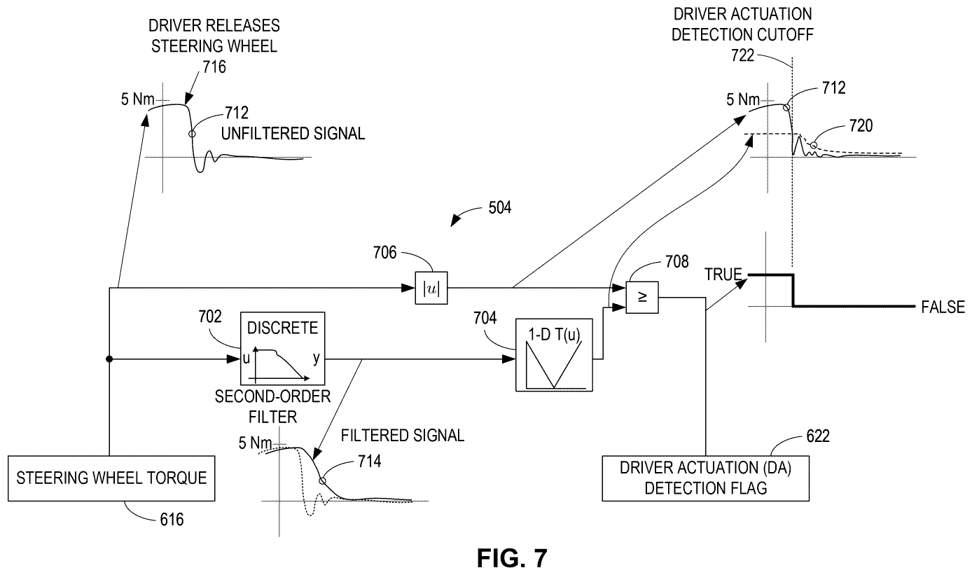

The over-center monitor circuitry 504 uses the mapped minimum threshold torque value to determine whether a subsequent one of the steering wheel torque values 616 corresponds to active driver steering input or corresponds to the spring-to-center steering wheel 202 freely oscillating back to a center position. For example, after detecting the maximum steering wheel torque value and mapping it to the minimum threshold torque value, the over-center monitor circuitry 504 uses the comparator circuitry 510 to perform comparisons between the minimum threshold torque value and subsequent ones of the steering wheel torque values 616 in the opposite direction of the maximum steering wheel torque value. If the comparator circuitry 510 detects that a subsequent one of the steering wheel torque values 616 satisfies (e.g., is equal to or exceeds) the minimum threshold torque value, the over-center monitor circuitry 504 activates or sets an example ‘driver actuation detection’ flag 622 to true. In examples disclosed herein, the ‘driver actuation detection’ flag 622 is used to indicate that the driver is actively steering. In some examples, the active steering by the driver is in a direction that is opposite a direction of the detected maximum steering wheel torque value. The over-center monitor circuitry 504 provides the ‘driver actuation detection’ flag 622 to the ‘current input target simulated SWA’ selection process 608 and the ‘output target simulated SWA’ determination process 612. Additional details of the over-center monitoring process 602 are described below in connection with FIGS. 7-10.

At the ‘current simulated SWA’ determination process 604, the steering wheel angle selector circuitry 506 determines a ‘current simulated SWA’ (SWA_{T}) based on the steering wheel torque value 616 and the road wheel speed 618. For example, the ‘current simulated SWA’ (SWA_{T}) corresponds to an amount of torque applied by a driver to the spring-to-center steering wheel 202 and a vehicle speed. In examples disclosed herein, the steering wheel torque values 616 and the road wheel speed values 618 are mapped (e.g., in a lookup table) to corresponding SWAs of a prior, fully rotatable steering wheel. Through such mappings, the steering wheel angle selector circuitry 506 translates the steering wheel torque values 616 at ones of the road wheel speed values 618 to equivalent SWAs of a prior, fully rotatable steering wheel. The steering wheel angle selector circuitry 506 provides the equivalent SWAs as simulated SWAs. A ‘current simulated SWA’ (SWA_{T}) corresponds to a current one of the steering wheel torque values 616 that represents torque currently exerted on the spring-to-center steering wheel 202 by a driver or by inertia causing free-movement oscillation of the spring-to-center steering wheel 202. In examples disclosed herein, the ‘current simulated SWA’ determination process 604 also bases the ‘current simulated SWA’ (SWA_{T}) on the road wheel speed values 618 by mapping larger SWAs to slower speeds and smaller SWAs to faster speeds. As such, a particular steering wheel torque detected during a slower road wheel speed produces a larger ‘current simulated SWA’ (SWA_{T}) at the ‘current simulated SWA’ determination process 604 than if that same steering wheel torque is detected during a faster road wheel speed.

At the ‘simulated hands-off SWA’ selection process 606, the steering wheel angle selector circuitry 506 selects a ‘simulated hands-off SWA’. In examples disclosed herein, a ‘simulated hands-off SWA’ simulates a SWA of a prior, fully rotatable steering wheel released by a driver and returning to a center position. For example, the ‘simulated hands-off SWA’ selection process 606 simulates a response of a prior, fully rotatable steering wheel based on a force from road wheels on a prior, fully rotatable steering shaft after a driver releases the prior, fully rotatable steering wheel and the road wheels caster to center. This simulation is based on the road wheel speed values 618, a ‘previous input target simulated SWA’ produced by the steer control instructions and/or operations 600, and a damping characteristic for a prior, fully rotatable steering shaft. The ‘simulated hands-off SWA’ selection process 606 uses a lookup table that maps ‘simulated hands-off SWA’ values to road wheel speed values, damping characteristics, and ‘previous input target simulated SWA’ values. The steering wheel angle selector circuitry 506 selects a damping characteristic corresponding to a road wheel speed value 618. The steering wheel angle selector circuitry 506 then selects a ‘simulated hands-off SWA’ based on the damping characteristic and a ‘previous input target simulated SWA’. For example, the damping characteristic simulates the slew rate (e.g., rate of change) from the ‘previous input target simulated SWA’ to a ‘current simulated hands-off SWA’ for a prior, fully rotatable steering wheel that has been released by a driver.

The damping characteristic at the ‘simulated hands-off SWA’ selection process 606 corresponds to how quickly or slowly (e.g., a slew rate) a steering wheel returns to a center position. In the example of FIG. 6, the damping characteristic is dynamic and based on a speed of the vehicle 100 (e.g., the road wheel speed values 618). For example, for slower vehicle speeds, the damping characteristic corresponds to a slower return to center of the steering wheel, and for faster vehicle speeds, the damping characteristic corresponds to a faster return to center of the steering wheel. This is commensurate with the return-to-center behavior of a prior, fully rotatable steering wheel at different vehicle speeds.

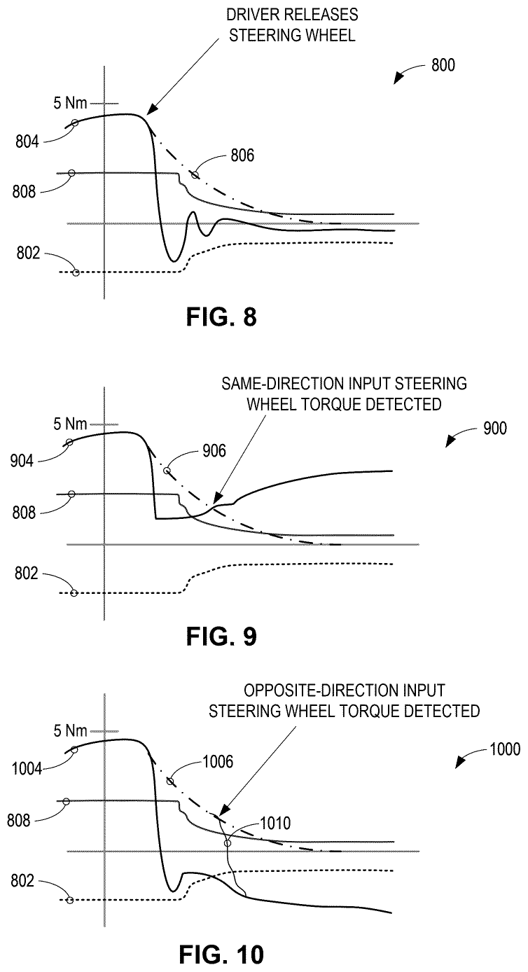

At the ‘current input target simulated SWA’ selection process 608, the steering wheel angle selector circuitry 506 selects one of the ‘current simulated SWA’ (SWA_{T}) from the ‘current simulated SWA’ determination process 604 or the ‘simulated hands-off SWA’ from the ‘simulated hands-off SWA’ selection process 606 as a ‘current input target simulated SWA’. In the ‘current input target simulated SWA’ selection process 608, the steering wheel angle selector circuitry 506 determines whether a driver is steering away from center or towards center and selects the ‘current simulated SWA’ (SWA_{T}) as the ‘current input target simulated SWA’ if the driver is steering away from center. For example, the steering wheel angle selector circuitry 506 uses the comparator circuitry 510 to determine whether the magnitude of the ‘current simulated SWA’ (SWA_{T}) is greater than or equal to the magnitude of the ‘previous simulated target SWA’ (SWA_{T-1}) (e.g., Is SWA_{T}>=SWA_{T-1}?). If the comparator circuitry 510 detects that the magnitude of the ‘current simulated SWA’ (SWA_{T}) is greater than or equal to the magnitude of the ‘previous target SWA (SWA_{T-1})’ and if driver actuation (DA) was detected at the over-center monitoring process 602, the steering wheel angle selector circuitry 506 uses the comparator circuitry 510 to determine whether the magnitude of the ‘simulated hands-off SWA’ is less than the magnitude of the ‘current simulated SWA’ (SWA_{T}) (e.g., Is simulated hands-off SWA<SWA_{T} ?). If the comparator circuitry 510 determines that the magnitude of the ‘simulated hands-off SWA’ is less than the magnitude of the ‘current simulated SWA’ (SWA_{T}), the steering wheel angle selector circuitry 506 selects the ‘current simulated SWA’ (SWA_{T}) as the ‘current input target simulated SWA’. For example, the steering wheel angle selector circuitry 506 sets the ‘current input target simulated SWA’ equal to the ‘current simulated SWA’ (SWA_{T}). Otherwise (e.g., else), if the comparator circuitry 510 determines that the magnitude of the ‘current simulated SWA’ (SWA_{T}) is not greater than or equal to the magnitude of the ‘previous target SWA’ (SWA_{T-1}), or if driver actuation (DA) was not detected at the over-center monitoring process 602, or if the comparator circuitry 510 determines that the magnitude of the ‘simulated hands-off SWA’ is not less than the magnitude of the ‘current simulated SWA’ (SWA_{T}), the steering wheel angle selector circuitry 506 selects the ‘simulated hands-off SWA’ value from the ‘simulated hands-off SWA’ selection process 606 as the ‘current input target simulated SWA’ value. For example, the steering wheel angle selector circuitry 506 sets the ‘current input target simulated SWA’ value equal to the ‘simulated hands-off SWA’ value. For example, the ‘simulated hands-off SWA’ value corresponds to the road wheels 108a, b returning to a straight path of travel. Example analyses that can be performed by the steering wheel angle selector circuitry 506 at the ‘current input target simulated SWA’ selection process 608 are described below in connection with FIGS. 8-10.

The one-loop delay 610 passes back the ‘current input target simulated SWA’ from the ‘current input target simulated SWA’ selection process 608 to the ‘simulated hands-off SWA’ selection process 606 during a subsequent loop or iteration of the steer control instructions and/or operations 600. As such, the one-loop delay 610 delays the ‘current input target simulated SWA’ value for one loop of the steer control instructions and/or operations 600 and passes the ‘current input target simulated SWA’ value as the ‘previous input target simulated SWA’ value to the ‘simulated hands-off SWA’ selection process 606. For example, during a second loop of the steer control instructions and/or operations 600, the ‘previous input target simulated SWA’ value is an initial (or first) ‘input target simulated SWA’ value and the ‘current input target simulated SWA’is a subsequent (or second) ‘input target simulated SWA’value.

At the ‘output target simulated SWA’ determination process 612, the blender circuitry 512 blends steering control from a default damping behavior (e.g., simulating caster steering return to center of a prior, fully rotatable steering wheel) to an active steering strategy. For example, the default damping behavior corresponds to the spring-to-center steering wheel 202 having been released by a driver and freely moving back to a center position. The active steering strategy corresponds to the over-center monitor circuitry 504 detecting driver actuation of the spring-to-center steering wheel 202 and setting the DA detection flag 622.

At the ‘output target simulated SWA’ determination process 612, the blender circuitry 512 detects when the DA detection flag 622 is set or activated by the over-center monitor circuitry 504 (e.g., the DA detection flag is transitioned from false to true). In response to the DA detection flag 622 being set to true, the blender circuitry 512 performs the steering strategy blending by blending the ‘current input target simulated SWA’ value from the ‘current input target simulated SWA’ selection process 608 with a ‘previous input target simulated SWA’ value of a previous iteration of the steer control instructions and/or operations 600 based on a current one of the steering wheel torque values 616. For example, the blender circuitry 512 latches (e.g., stores) the ‘previous input target simulated SWA’ value in a local register, cache, or memory at a time when the DA detection flag 622 is activated to true. The blender circuitry 512 then blends from the ‘previous input target simulated SWA’ value latched in memory to the ‘current input target simulated SWA’ value to generate ‘output target simulated SWA’ values over several iterations until the blend is complete. In the example of FIG. 6, the blender circuitry 512 bases the rate of blend on the current one of the steering wheel torque values 616. For example, a stronger driver input steering wheel torque represents a driver's intent to turn the road wheels 108a, b more quickly than if the driver input steering wheel torque is weaker. In some examples, the blend rate is low at low driver input steering wheel torque values and high at high driver input steering wheel torque values. This adjusting of the blend rate allows for rapid counter-steering capabilities.

To perform the blending at the ‘output target simulated SWA’ determination process 612, the blender circuitry 512 can use a table of ‘blended target simulated SWA’ values mapped to ‘current input target simulated SWA’ values. Alternatively, the blender circuitry 512 can use a function that is applied by, for example, the arithmetic logic circuitry 508. For example, the blender circuitry 512 may use the arithmetic logic circuitry 508 to calculate an average of the ‘previous input target simulated SWA’ value latched in memory and the ‘current input target simulated SWA’ value to generate an ‘output target simulated SWA’ value. In either case, the blender circuitry 512 controls the rate of change in the steering wheel torque value 616 to the road wheel actuator 102 so that the resulting steering action is smooth and not a step function or series of step functions.

At the global rate limiter process 614, the rate limiter circuitry 514 receives ‘output target simulated SWA’ values from the ‘output target simulated SWA’ determination process 612. At the global rate limiter process 614, the rate limiter circuitry 514 limits a rate of change associated with the ‘output target simulated SWA’ values based on a threshold slew rate corresponding to a prior, fully rotatable steering wheel. That is, the rate limiter circuitry 514 limits the mechanical slew rate of the ‘output target simulated SWA’ values that are to be implemented as road wheel angles by the road wheel actuator 102 based on a typical rate of rotation of a prior, fully rotatable steering wheel operated by a human being. For example, to closely emulate a steering maneuver that could be performed by a human driver using a prior, fully rotatable steering wheel, the rate limiter circuitry 514 may be provided with a mapping of SWA change rates to different road wheel speed values. For example, a faster SWA change rate may be allowed at slower road wheel speeds than at faster road wheel speeds. The rate limiter circuitry 514 uses such mapped values to limit the ‘output target simulated SWA’ values to SWAs that do not cause exceeding of a threshold SWA change rate based on a current SWA. For example, if the difference between an ‘output target simulated SWA’ value of the ‘output target simulated SWA’ values and a current SWA value controlling the road wheel actuator 102 corresponds to a SWA change rate that exceeds a maximum threshold SWA change rate specified in the rate limiter circuitry 514, the rate limiter circuitry 514 decreases the ‘output target simulated SWA’ value to an ‘output target simulated SWA’ value that does not cause the SWA change rate to exceed the maximum threshold SWA change rate.

After the rate limiter circuitry 514 creates final ‘output target simulated SWA’ values, the center-crossing steer controller 107 creates example SWA steer commands that include corresponding ones of the final ‘output target simulated SWA’ values. The interface circuitry 502 provides the SWA steer commands to the road wheel actuator 102. The road wheel actuator 102 controls the road wheel angles (e.g., steering pinion angles) of the road wheels 108a, b based on the final ‘output target simulated SWA’values in the SWA steer commands.

FIG. 7 is an example block diagram of the over-center monitor circuitry 504 to implement the over-center monitoring process 602 of FIG. 6. The over-center monitor circuitry 504 implements the over-center monitoring process 602 to detect a highest torque value between unfiltered ones of the steering wheel torque values 616 and filtered ones of the steering wheel torque values 616 to determine when the spring-to-center steering wheel 202 is no longer oscillating and driver actuation is detected (e.g., a driver of the vehicle 100 is counter-steering). In the example of FIG. 7, the over-center monitor circuitry 504 does not detect driver actuation when a driver wishes for the road wheels 108a, b to caster back to center by letting go of the spring-to-center steering wheel 202 and allowing the spring-to-center steering wheel 202 to settle back at center.

The over-center monitor circuitry 504 includes an example filter 702, an example torque input-to-threshold map 704 (e.g., a lookup table), an example absolute value converter 706, and an example comparator 708. The filter 702, the torque input-to-threshold map 704, the absolute value converter 706, and/or the comparator 708 may be instantiated by programmable circuitry executing instructions (e.g., firmware or software) and/or configured to perform corresponding operations. Additionally or alternatively, some or all of the filter 702, the torque input-to-threshold map 704, the absolute value converter 706, and/or the comparator 708 could be implemented by one of or any combination of analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs.

The filter 702 receives the steering wheel torque values 616 as an example unfiltered signal 712 and creates an example filtered signal 714 by removing high-frequency components from the steering wheel torque values 616 and adding delay to the steering wheel torque values 616. The filter 702 may be implemented using any suitable type of filter. In the illustrated example of FIG. 7, the filter 702 is shown as a discrete-time filter. However, the filter 702 could alternatively be implemented as a continuous-time filter. The unfiltered signal 712 shows an example inflection point 716 representative of a driver releasing the spring-to-center steering wheel 202, followed by high-frequency oscillation components. The filtered signal 714 still represents the inflection point 716 from the unfiltered signal 712 but not the high-frequency components of the unfiltered signal 712.

The torque input-to-threshold map 704 stores input steering wheel torque values in association with (mapped to) minimum threshold torque values. The minimum threshold torque values are to be satisfied (e.g., exceeded) by the unfiltered signal 712 to be considered a driver-actuated torque instead of merely torque passively generated by the spring-to-center steering shaft 204 oscillating after a driver releases the spring-to-center steering wheel 202 expecting the road wheels 108a, b to caster back to center. The torque input-to-threshold map 704 receives the filtered signal 714 and selects corresponding minimum threshold torque values for filtered ones of the steering wheel torque values 616 in the filtered signal 714. Accordingly, the torque input-to-threshold map 704 outputs the selected minimum threshold torque values to the comparator 708 as an example threshold torque signal 720.

The absolute value converter 706 receives the unfiltered signal 712 and creates absolute values of the corresponding steering wheel torque values 616 by converting negative numbers to corresponding positive numbers (e.g., removing the negative sign from negative ones of the steering wheel torque values 616). The absolute value converter 706 converts the steering wheel torque values 616 to absolute values in the example of FIG. 7 so that the comparator 708 can make comparisons based on positive values. Since oscillations in the unfiltered signal 712 are symmetrical around zero, the absolute value conversions allow the comparator 708 to perform comparisons based on positive values while producing results consistent with the steering wheel torque values 616. Additionally, the absolute value converter 706 serves as a simplification because a detection of a torque value above a minimum threshold torque value on the same side (e.g., a counterclockwise steering angle or a clockwise steering angle) as the local maximum torque value before the spring-to-center steering wheel 202 is released by a driver is handled by the ‘select current input target simulated SWA’ process 608 by passing the ‘simulated hands off SWA’ from the ‘simulated hands-off SWA’ selection process 606 to the ‘output target simulated SWA’ determination process 612.

The comparator 708 compares the unfiltered signal 712 with the threshold torque signal 720 to determine whether driver actuation is detected. In the example of FIG. 7, the delay added by the second-order filter 702 in the filtered signal 714 and the calibration of the torque input-to-threshold map 704 are designed to be slightly greater than the natural oscillation response of the spring-to-center steering wheel 202 when springing back to center with the driver's hands off the spring-to-center steering wheel 202. This is reflected in the threshold torque signal 720 which is created to be an envelope. Torque values below that envelope are treated as system response and not driver intent.

In the example of FIG. 7, an example driver actuation detection cutoff 722 identifies the point of intersection between the unfiltered signal 712 and the threshold torque signal 720 at which driver actuation detection transitions from true to false. That is, before the driver actuation detection cutoff 722, driver actuation is detected (e.g., driver actuation detection =True) due to a driver steering in a particular direction (e.g., a counterclockwise direction) and after the driver actuation detection cutoff 722, driver actuation is no longer detected (e.g., driver actuation detection =False) due to a driver having released the spring-to-center steering wheel 202 and not actively counter steering in the opposite direction. Based on the output of the comparator 708, the over-center monitoring circuitry 504 sets or clears the DA detection flag 622 at the over-center monitoring process 602. For example, if driver actuation detection is true at the comparator 708, the over-center monitoring circuitry 504 sets the DA detection flag 622 to true and if driver actuation detection is false at the comparator 708, the over-center monitoring circuitry 504 clears the DA detection flag 622 to false.

FIG. 8 is an example torque response graph 800 corresponding to a driver releasing the spring-to-center steering wheel 202 and intending for the road wheels 108a, b to passively caster back to center. FIG. 9 is an example torque response graph 900 corresponding to the driver applying same-direction input steering wheel torque to the spring-to-center steering wheel 202. FIG. 10 is an example torque response graph 1000 corresponding to the driver applying opposite-direction input steering wheel torque to the spring-to-center steering wheel 202. The torque response graphs 800, 900, 1000 an example threshold torque signal 802 plotted against corresponding example unfiltered signals 804, 904, 1004 of corresponding steering wheel torque values. However, the threshold torque signal 802 and the unfiltered signals 804, 904, 1004 are not to scale. Instead, since there is a mapped relationship between threshold torque signal 802 and the steering wheel torque values of the unfiltered signals 804, 904, 1004, the signals are scaled to show where transitions in driver steering strategy occur.

In the torque response graph 800 of FIG. 8, when the driver releases the spring-to-center steering wheel 202, the steering wheel angle selector circuitry 506 selects an example ‘simulated hands-off SWA’ signal 806 in the ‘current input target simulated SWA’ selection process 608 because the simulated hands-off SWA values from the ‘simulated hands-off SWA’ selection process 606 are greater than the ‘current simulated SWA’ (SWA_{T}) values from the ‘current simulated SWA’ determination process 604. For visualization purposes, the torque response graphs 800, 900, 1000 of FIGS. 8-10 also show an example envelope 808 that includes mirrored values of the threshold torque signal 802. The envelope 808 is the envelope of the unfiltered signal 804 which represents a driver releasing the spring-to-center steering wheel 202 and the spring-to-center steering wheel 202 freely oscillating back to center without user intervention.

From the scenario represented by the torque response graph 800, a driver may allow the spring-to-center steering wheel 202 to passively return to center. Alternatively, the driver may return to actively steering in the same direction relative to previous driver-applied steering as represented by the torque response graph 900 of FIG. 9 or may actively counter steer in the opposite direction relative to previous driver-applied steering as represented by the torque response graph 1000 of FIG. 10.

The torque response graph 900 of FIG. 9 includes an example ‘simulated hands-off SWA’ signal 906 from the ‘simulated hands-off SWA’ selection process 606 that intersects the unfiltered signals 904 of steering wheel torque values. In the example of FIG. 9, the unfiltered signals 904 of steering wheel torque values are ‘current simulated SWA’ (SWA_{T}) values from the ‘current simulated SWA’ determination process 604. That intersection represents the point at which the driver applies torque to the spring-to-center steering wheel 202 in the same direction as they had previously applied torque. The torque response graph 900 shows that this newly applied same-direction torque, represented by the ‘current simulated SWA’ (SWA_{T}) values, exceeds the ‘simulated hands-off SWA’ signal 906. Accordingly, the DA detection flag 622 is set to true at the over-center monitoring process 602 due to detection of driver actuation in the same direction as a previous driver-applied steering direction. Subsequently, at the ‘current input target simulated SWA’ selection process 608, the steering wheel angle selector circuitry 506 selects the ‘current simulated SWA’ (SWA_{T}) values from the ‘current simulated SWA’ determination process 604 and provides the ‘current simulated SWA’(SWA_{T}) values to the ‘output target simulated SWA’determination process 612.

The torque response graph 1000 of FIG. 10 includes an example ‘simulated hands-off SWA’ signal 1006 from the ‘simulated hands-off SWA’ selection process 606 and the unfiltered signal 1004 of steering wheel torque values. In the example of FIG. 10, the unfiltered signals 1004 of steering wheel torque values are ‘current simulated SWA’ (SWA_{T}) values from the ‘current simulated SWA’ determination process 604. In the torque response graph 1000, the driver applies torque to the spring-to-center steering wheel 202 in the opposite direction of previous driver-applied steering torque. The torque response graph 1000 shows that this newly applied opposite-direction torque, represented by the ‘current simulated SWA’ (SWA_{T}) values, exceeds the envelope 808. Accordingly, the DA detection flag 622 is set to true at the over-center monitoring process 602 due to detection of driver actuation in the opposite direction as a previous driver-applied steering direction. Subsequently, at the ‘current input target simulated SWA’ selection process 608, the steering wheel angle selector circuitry 506 determines that the driver is steering away from center, selects the ‘current simulated SWA’ (SWA_{T}) values and provides the ‘current simulated SWA’ (SWA_{T}) values to the ‘output target simulated SWA’ determination process 612. At the ‘output target simulated SWA’ determination process 612, the blender circuitry 512 blends the current damping/simulated caster response SWA to the ‘current simulated SWA’ (SWA_{T}) values. In doing so, the blender circuitry 512 generates ‘output target simulated SWA’ values that transition from the ‘simulated hands-off SWA’ signal 1006 to an example blend line 1010 and on to the unfiltered signal 1004.

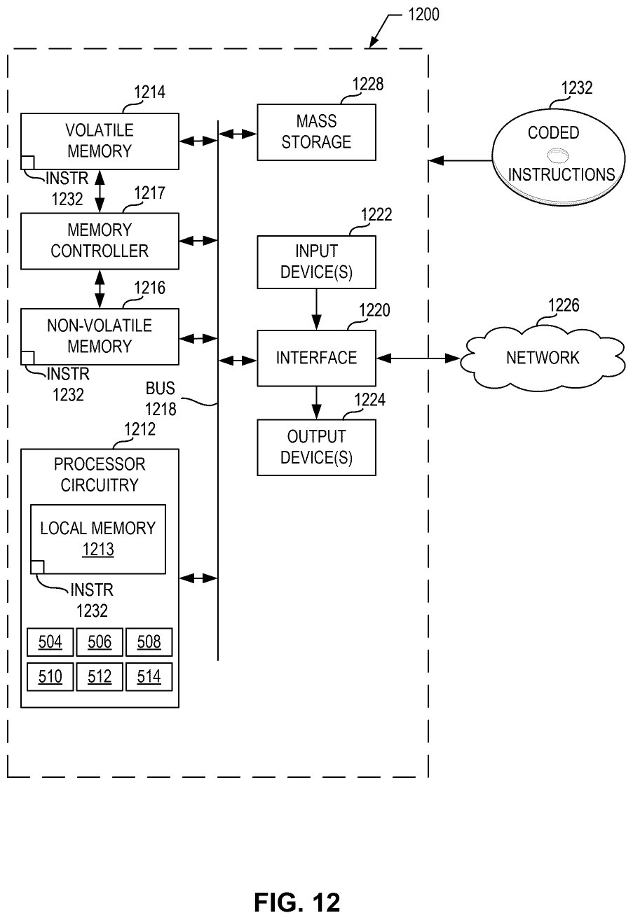

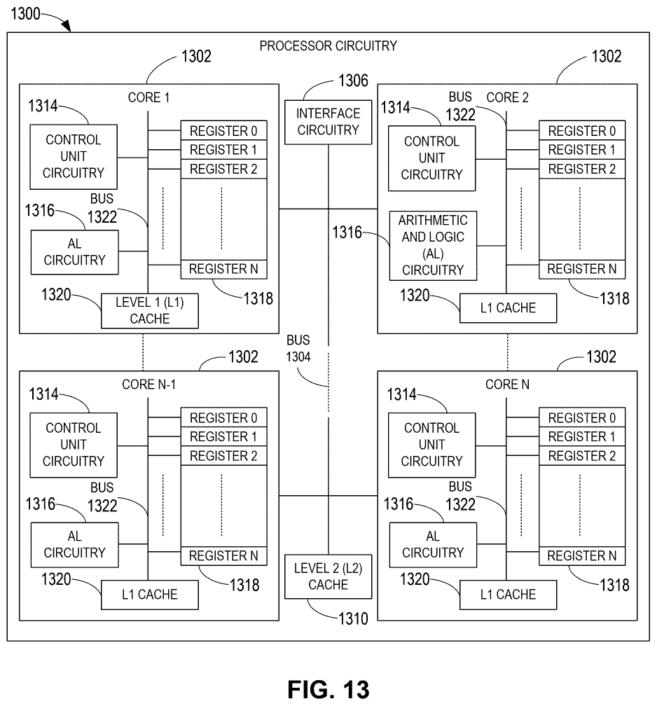

A flowchart representative of example machine-readable instructions, which may be executed by programmable circuitry to implement and/or instantiate the center-crossing steer controller 107 of FIG. 5 and/or representative of example operations which may be performed by programmable circuitry to implement and/or instantiate the center-crossing steer controller 107 of FIG. 5, is shown in FIG. 11. The machine-readable instructions may be one or more executable program(s) or portion(s) of one or more executable program(s) for execution by programmable circuitry such as the programmable circuitry 1212 shown in the example processor platform 1200 discussed below in connection with FIG. 12 and/or may be one or more function(s) or portion(s) of functions to be performed by the example programmable circuitry (e.g., an FPGA) discussed below in connection with FIGS. 13 and/or 14. In some examples, the machine-readable instructions cause an operation, a task, etc., to be carried out and/or performed in an automated manner in the real world. As used herein, “automated” means without human involvement.

The program(s) may be embodied in instructions (e.g., software and/or firmware) stored on one or more non-transitory computer-readable and/or machine-readable storage media such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, read-only memory (ROM), a solid-state drive (SSD), non-volatile memory (e.g., electrically erasable programmable ROM (EEPROM), flash memory, etc.), volatile memory (e.g., Random Access Memory (RAM) of any type, etc.), and/or any other storage device or storage disk. The non-transitory computer-readable storage medium may include one or more mediums and/or types of mediums. The instructions of the non-transitory computer-readable and/or machine-readable medium may be executed and/or instantiated by one or more hardware devices other than the programmable circuitry and/or may be embodied in dedicated hardware. For example, any or all of the blocks of the flowchart(s) may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform corresponding operations without executing software or firmware.

Although the example program(s) is/are described with reference to the flowchart illustrated in FIG. 11, many other methods of implementing the example center-crossing steer controller 107 may alternatively be used. For example, the order of execution of the blocks of the flowchart may be changed, and/or some of the blocks described may be changed, eliminated, or combined.

The machine-readable instructions may be distributed across multiple hardware devices and/or executed by two or more hardware devices (e.g., a server and a client hardware device). The programmable circuitry may be distributed in different network locations and/or may be local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

Machine-readable instructions as described herein may be stored as data and/or in a data structure (e.g., as portion(s) of instructions, code, representations of code, etc.) on one or more storage devices, disks and/or computing devices (e.g., servers) located at the same or different locations of a network or collection of networks (e.g., in the cloud, in edge devices, etc.).

The machine-readable instructions described herein can be written or represented using any suitable previously developed or future-developed instruction language, scripting language, programming language, etc. including, for example, C, C++, Java, C-Sharp, Perl, Python, JavaScript, HyperText Markup Language (HTML), Structured Query Language (SQL), Swift, model-based design (e.g., Simulink), etc.

As mentioned above, the example operations of FIG. 11 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc. As used herein, the term “storage disk” refers to a physical structure containing information storage elements to which information can be written and persisted for subsequent retrieval by a computer or other hardware platform. Examples of non-transitory computer-readable medium, non-transitory computer-readable storage medium, non-transitory machine-readable medium, non-transitory machine-readable storage medium, non-transitory computer-readable storage devices, non-transitory machine-readable storage devices, non-transitory computer-readable storage disk, and/or non-transitory machine-readable storage disk include any one of or combination of random access memory (RAM) of any type, read only memory (ROM) of any type, solid state memory, flash memory, optical discs (e.g., a CD, a DVD, etc.), magnetic disks (e.g., magnetic HDDs), disk drives, cache, registers, redundant array of independent disks (RAID) systems, and/or any other non-transitory computer-readable and/or machine-readable media in which information is stored for any duration (e.g., for extended time periods, permanently, for brief instances, for temporarily buffering, and/or for caching of the information).

FIG. 11 is a flowchart representative of example machine readable instructions and/or example operations 1100 that may be executed, instantiated, and/or performed by example programmable circuitry to implement the center-crossing steer controller 107 of FIG. 5. Although blocks representing the instructions and/or operations 1100 are shown in seriatim in FIG. 11, one or more blocks may instead be executed in parallel with others of the blocks. The example machine-readable instructions and/or the example operations 1100 of FIG. 11 begin at block 1102, at which the interface circuitry 502 obtains (or accesses) the steering wheel torque value 616 corresponding to a torque applied to the spring-to-center steering wheel 202. At block 1104, the interface circuitry 502 obtains (or accesses) the road wheel speed 618. At block 1106, the comparator circuitry 510 compares the steering wheel torque value 616 to a threshold torque value. At block 1108, the over-center monitor circuitry 504 determines whether over-center driver actuation steering is detected. For example, the over-center monitor circuitry 504 determines that over-center driver actuation steering is detected if the comparator circuitry 510 detects that the steering wheel torque value 616 satisfies (e.g., is equal to or exceeds) a minimum threshold torque value as described above in connection with FIGS. 6-10. If the over-center monitor circuitry 504 determines that over-center driver actuation steering is not detected (block 1108: NO), control returns to block 1102. If the over-center monitor circuitry 504 determines that over-center driver actuation steering is detected (block 1108: YES), the steering wheel angle selector circuitry 506 determines a ‘current input target simulated SWA’ value (block 1110). For example, the steering wheel angle selector circuitry 506 determines a ‘current input target simulated SWA’ value as described above in connection with the ‘current input target simulated SWA’selection process 608 of FIG. 6.

At block 1112, the blender circuitry 512 determines an ‘output target simulated SWA’ value. For example, the blender circuitry 512 determines an ‘output target simulated SWA’ value based on a blending of the ‘current input target simulated SWA’ value and a ‘previous input target simulated SWA’ value as described above in connection with the ‘output target simulated SWA’ determination process 612 of FIG. 6. At block 1114, the rate limiter circuitry 514 limits a rate of change for road wheel steer angle. For example, the rate limiter circuitry 514 limits the rate of change for the road wheel steer angle as described above in connection with the global rate limiter process 614 of FIG. 6. At block 1116, the center-crossing steer controller 107 controls the road wheel actuator 102. For example, the interface circuitry 502 sends a SWA steer command that includes the ‘output target simulated SWA’ value to the road wheel actuator 102 so that the road wheel actuator 102 can turn the road wheels 108a, b based on the ‘output target simulated SWA’value in the SWA steer command.

The instructions and/or operations 1100 of FIG. 11 end. Alternatively, the instructions and/or operations 1100 can be repeated multiple times (e.g., a loop execution) throughout a driving session. For example, the steering wheel torque value 616 and the road wheel speed 618 can be continuously monitored and the instructions and/or operations 1100 can be repeated continuously to generate SWA steer commands. In some examples, the loop execution of the instructions and/or operations 1100 ends when the vehicle 100 is placed into a park mode and/or the vehicle 100 is turned off.

FIG. 12 is a block diagram of an example programmable circuitry platform 1200 structured to execute and/or instantiate the example machine-readable instructions and/or the example operations of FIG. 11 to implement the center-crossing steer controller 107 of FIG. 5. The programmable circuitry platform 1200 can be, for example, an ECU, a self-learning machine (e.g., a neural network), or any other type of computing and/or electronic device.

The programmable circuitry platform 1200 of the illustrated example includes programmable circuitry 1212. The programmable circuitry 1212 of the illustrated example is hardware. For example, the programmable circuitry 1212 can be implemented by one or more integrated circuits, logic circuits, FPGAs, microprocessors, CPUs, GPUs, DSPs, XPUs, and/or microcontrollers from any desired family or manufacturer. The programmable circuitry 1212 may be implemented by one or more semiconductor based (e.g., silicon based) devices. In this example, the programmable circuitry 1212 implements the over-center monitor circuitry 504, the steering wheel angle selector circuitry 506, the arithmetic logic circuitry 508, the comparator circuitry 510, the blender circuitry 512, and the rate limiter circuitry 514.

The programmable circuitry 1212 of the illustrated example includes a local memory 1213 (e.g., a cache, registers, etc.). The programmable circuitry 1212 of the illustrated example is in communication with main memory 1214, 1216, which includes a volatile memory 1214 and a non-volatile memory 1216, by a bus 1218. The volatile memory 1214 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1216 may be implemented by flash memory and/or any other desired type of memory device. Access to the main memory 1214, 1216 of the illustrated example is controlled by a memory controller 1217. In some examples, the memory controller 1217 may be implemented by one or more integrated circuits, logic circuits, microcontrollers from any desired family or manufacturer, or any other type of circuitry to manage the flow of data going to and from the main memory 1214, 1216.

The programmable circuitry platform 1200 of the illustrated example also includes interface circuitry 1220. The interface circuitry 1220 may be implemented by hardware in accordance with any type of interface standard, such as a CAN bus interface, a Local Interconnect Network (LIN) bus interface, a Media Oriented Systems Transport (MOST) bus interface, an Automotive Ethernet bus interface, a universal serial bus (USB) interface, etc. In the example of FIG. 12, the interface circuitry 1220 implements the interface circuitry 502 of FIG. 5. In the illustrated example, a plurality of input devices 1222 are connected to the interface circuitry 1220. The input devices 1222 permit measuring parameters of the vehicle 100. In examples disclosed herein, the input devices 1222 include the steering torque sensor 106, the speed sensor 110, and the ABS controller 118 of FIG. 1.

One or more output devices 1224 are also connected to the interface circuitry 1220 of the illustrated example. The output device(s) 1224 can be implemented, for example, by light emitting diodes (LEDs), organic light emitting diodes (OLEDs), a liquid crystal display (LCD), and/or speakers. In some examples, the interface circuitry 1220 includes a graphics driver card, a graphics driver chip, and/or graphics processor circuitry such as a GPU.

The interface circuitry 1220 of the illustrated example also includes a communication device such as a transmitter, a receiver, a transceiver, a modem, a wireless access point, and/or a network interface to facilitate exchange of data with internal and/or external machines (e.g., computing devices of any kind) by a network 1226. The communication can be by, for example, a satellite system, a beyond-line-of-sight wireless system, a line-of-sight wireless system, a cellular telephone system, etc.

The programmable circuitry platform 1200 of the illustrated example also includes one or more mass storage discs or devices 1228 to store firmware, software, and/or data. Examples of such mass storage discs or devices 1228 include magnetic storage devices, optical storage devices, and/or solid-state storage discs or devices such as flash memory devices and/or SSDs.

The machine-readable instructions 1232, which may be implemented by the machine-readable instructions of FIG. 11, may be stored in the mass storage device 1228, in the volatile memory 1214, in the non-volatile memory 1216, and/or on at least one non-transitory computer-readable storage medium which may be removable.

FIG. 13 is a block diagram of an example implementation of the programmable circuitry 1212 of FIG. 12. In this example, the programmable circuitry 1212 of FIG. 12 is implemented by a microprocessor 1300. For example, the microprocessor 1300 may be a general-purpose microprocessor (e.g., general-purpose microprocessor circuitry). The microprocessor 1300 and/or components thereof may include additional and/or alternate structures to those shown and described below. The microprocessor 1300 is a semiconductor device fabricated to include transistors interconnected to implement the structures described below in one or more integrated circuits (ICs) contained in one or more packages.

The microprocessor 1300 executes machine-readable instructions of the flowchart of FIG. 11 to instantiate the circuitry of FIG. 5 as logic circuits to perform operations corresponding to those machine-readable instructions. In some such examples, the circuitry of FIG. 5 is instantiated by the hardware circuits of the microprocessor 1300 in combination with the machine-readable instructions. For example, the microprocessor 1300 may be implemented by multi-core hardware circuitry such as a CPU, a DSP, a GPU, an XPU, etc. Although it may include any number of example cores 1302 (e.g., 1 core), the microprocessor 1300 of this example is a multi-core semiconductor device including N cores. The cores 1302 of the microprocessor 1300 may operate independently or may cooperate to execute machine-readable instructions. For example, machine code corresponding to a firmware program, an embedded software program, or a software program represented by the flowchart of FIG. 11 may be executed by one of the cores 1302 or may be executed by multiple ones of the cores 1302 at the same or different times. In some examples, the machine code corresponding to the firmware program, the embedded software program, or the software program is split into threads and executed in parallel by two or more of the cores 1302. The software program may correspond to a portion or all of the machine-readable instructions and/or operations represented by the flowchart of FIG. 11.

The cores 1302 may communicate by a first example bus 1304. For example, the first bus 1304 may be implemented by any suitable bus technology (e.g., an Inter-Integrated Circuit (I2C) bus, a Serial Peripheral Interface (SPI) bus, a PCI bus, a PCIe bus, a CAN bus, a LIN bus interface, a MOST bus interface, an Automotive Ethernet bus interface, etc.). Data, instructions, and/or signals may be communicated (e.g., accessed, obtained, output, provided, etc.) between the cores 1302 and one or more external devices by example interface circuitry 1306. Although the cores 1302 of this example include example local cache 1320 (e.g., Level 1 (L1) cache that may be split into an L1 data cache and an L1 instruction cache), the microprocessor 1300 also includes example shared cache 1310. The shared cache 1310 is shared by the cores (e.g., Level 2 (L2 cache)) to access data and/or instructions across the cores.

Each core 1302 includes control unit circuitry 1314, arithmetic and logic (AL) circuitry (sometimes referred to as an arithmetic logic unit (ALU)) 1316, a plurality of registers 1318 (e.g., hardware registers), the local cache 1320, and a second example bus 1322. The control unit circuitry 1314 controls (e.g., coordinates) data movement within the corresponding core 1302. The AL circuitry 1316 performs one or more mathematic and/or logic operations on the data within the corresponding core 1302.

The registers 1318 store data and/or instructions such as results of operations performed by the AL circuitry 1316. The second bus 1322 may be implemented using any suitable bus technology (e.g., an I2C bus, a SPI bus, a PCI bus, or a PCIe bus, etc.).

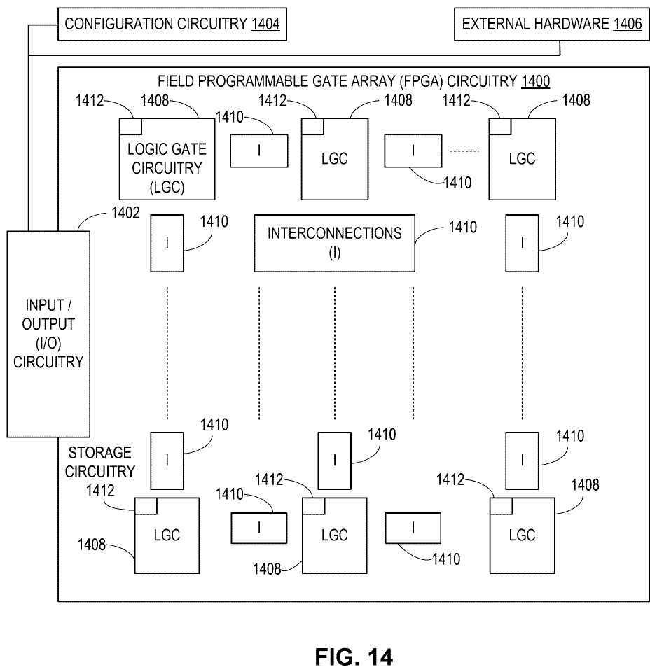

FIG. 14 is a block diagram of another example implementation of the programmable circuitry 1212 of FIG. 12. In this example, the programmable circuitry 1212 is implemented by FPGA circuitry 1400. Programmable logic circuitry of the FPGA circuitry 1400 may be programmed to create dedicated logic circuits that perform operations and/or functions represented in the flowchart of FIG. 11. For example, the FPGA circuitry 1400 includes interconnections and logic circuitry (e.g., logic gates, switches, etc.) that may be configured, structured, programmed, and/or interconnected in different ways to instantiate some or all of the operations/functions corresponding to the machine-readable instructions represented by the flowchart of FIG. 11. After an FPGA programming process, the FPGA circuitry 1400 instantiates the operations and/or functions corresponding to the machine-readable instructions in hardware. In some examples, the FPGA circuitry 1400 can execute the operations/functions faster than they could be performed by a general-purpose microprocessor.

The FPGA circuitry 1400 of FIG. 14, includes example input/output (I/O) circuitry 1402 to obtain data from and/or output data to example configuration circuitry 1404 and/or external hardware 1406 (e.g., microprocessor circuitry, controller circuitry, memory circuitry, storage circuitry, a computer, etc.). For example, the configuration circuitry 1404 may be implemented by interface circuitry that obtains a binary file to program or configure the FPGA circuitry 1400.

The FPGA circuitry 1400 also includes an array of example logic gate circuitry 1408, a plurality of example configurable interconnections 1410, and example storage circuitry 1412. The logic gate circuitry 1408 and the configurable interconnections 1410 are configurable to instantiate one or more operations/functions that may correspond to machine-readable instructions of FIG. 11 and/or other desired operations.

The storage circuitry 1412 is structured to store result(s) of operations performed by corresponding logic gates. The storage circuitry 1412 may be implemented by registers or the like.

Although not shown, the example FPGA circuitry 1400 of FIG. 14 also includes example dedicated operations circuitry to implement functions without programming those functions in the logic gate circuitry 1408. The FPGA circuitry 1400 may also include general purpose programmable circuitry such as a CPU, a DSP, etc.

Although FIGS. 13 and 14 illustrate two example implementations of the programmable circuitry 1212 of FIG. 12, many other approaches are contemplated. For example, a hybrid circuitry example may include one or more cores 1302 of FIG. 13 that execute(s) a first portion of the machine-readable instructions represented by the flowchart of FIG. 11 to perform first operation(s)/function(s), and/or include the FPGA circuitry 1400 of FIG. 14 configured and/or structured to perform second operation(s)/function(s) corresponding to a second portion of the machine-readable instructions represented by the flowchart of FIG. 11, and/or include an ASIC configured and/or structured to perform third operation(s)/function(s) corresponding to a third portion of the machine-readable instructions represented by the flowchart of FIG. 11.

As used herein, integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

In some examples, the programmable circuitry 1212 of FIG. 12 may be in one or more packages. For example, the microprocessor 1300 of FIG. 13 and/or the FPGA circuitry 1400 of FIG. 14 may be in one or more packages. “Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” modifies its subjects/values to recognize the potential presence of variations that occur in real world applications. For example, “approximately” may modify dimensions that may not be exact due to manufacturing tolerances and/or other real world imperfections as will be understood by persons of ordinary skill in the art. For example, “approximately” may indicate such dimensions may be within a tolerance range of +/−10% unless otherwise specified herein.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

Example methods, apparatus, systems, and articles of manufacture to implement SBW vehicle steering control based on crossing through center of a spring-to-center steering wheel are disclosed herein. Further examples and combinations thereof include the following:

Example 1 includes a steer-by-wire system comprising interface circuitry to obtain a steering wheel torque value corresponding to a torque applied to a spring-to-center steering wheel, machine-readable instructions, and at least one processor circuit to be programmed by the machine-readable instructions to at least after the steering wheel torque value satisfies a threshold value, determine an output target steering wheel angle value based on a blending of a current input target simulated steering wheel angle value and a previous input target simulated steering wheel angle value, and control a road wheel actuator to turn a road wheel based on the output target steering wheel angle value.

Example 2 includes the steer-by-wire system of example 1, wherein the spring-to-center steering wheel is coupled to an end of a spring-to-center steering shaft in a vehicle, the spring-to-center steering shaft having a portion statically fixed to a structure, the structure to prevent rotation of the portion of the spring-to-center steering shaft, the spring-to-center steering wheel rotationally restricted by a torsional rigidity of the spring-to-center steering shaft.

Example 3 includes the steer-by-wire system of example 1 and/or example 2, wherein the interface circuitry is to obtain the steering wheel torque value based on at least one of a shaft torque sensor or a load cell, the at least one of the shaft torque sensor or the load cell to sense the torque transferred from the spring-to-center steering wheel to a spring-to-center steering shaft.

Example 4 includes the steer-by-wire system of any one or more of examples 1-3, wherein the steering wheel torque value is based on a geared angle sensor coupled to a spring-to-center steering shaft.

Example 5 includes the steer-by-wire system of any one or more of examples 1-4, wherein one or more of the at least one processor circuit is to determine a current simulated steering wheel angle value based on the steering wheel torque value and a road wheel speed, and after determining that the current simulated steering wheel angle value is greater than or equal to a previous simulated steering wheel angle value, set the current input target simulated steering wheel angle value equal to the current simulated steering wheel angle value.

Example 6 includes the steer-by-wire system of any one or more of examples 1-5, wherein one or more of the at least one processor circuit is to determine a current simulated steering wheel angle value based on the steering wheel torque value and a road wheel speed, and after determining that the current simulated steering wheel angle value is not greater than or equal to a previous simulated steering wheel angle value, set the current input target simulated steering wheel angle value equal to a simulated hands-off steering wheel angle value corresponding to the road wheel returning to a straight path of travel.

Example 7 includes the steer-by-wire system of any one or more of examples 1-6, wherein one or more of the at least one processor circuit is to determine that the steering wheel torque value exceeds the threshold value in a first direction, the first direction opposite a second direction in which a previous steering wheel torque value was applied to the spring-to-center steering wheel.

Example 8 includes at least one non-transitory machine-readable medium comprising machine-readable instructions to cause at least one processor circuit to at least access a steering wheel torque value corresponding to a torque applied to a spring-to-center steering wheel coupled to a spring-to-center steering shaft, after the steering wheel torque value satisfies a threshold value, determine an output target steering wheel angle value based on a blending of a current input target simulated steering wheel angle value and a previous input target simulated steering wheel angle value, and control a road wheel actuator to turn a road wheel based on the output target steering wheel angle value.

Example 9 includes the at least one non-transitory machine-readable medium of example 8, wherein the steering wheel torque value is based on a torsional rigidity of the spring-to-center steering shaft.

Example 10 includes the at least one non-transitory machine-readable medium of example 8 and/or example 9, wherein the steering wheel torque value is based on a signal from at least one of a shaft torque sensor or a load cell, the signal corresponding to the torque transferred from the spring-to-center steering wheel to the spring-to-center steering shaft.

Example 11 includes the at least one non-transitory machine-readable medium of any one or more of examples 8-10, wherein the steering wheel torque value is based on a geared angle sensor coupled to the spring-to-center steering shaft.

Example 12 includes the at least one non-transitory machine-readable medium of any one or more of examples 8-11, wherein the machine-readable instructions are to cause one or more of the at least one processor circuit to determine a current simulated steering wheel angle value based on the steering wheel torque value and a road wheel speed, and after determining that the current simulated steering wheel angle value is greater than or equal to a previous simulated steering wheel angle value, set the current input target simulated steering wheel angle value equal to the current simulated steering wheel angle value.

Example 13 includes the at least one non-transitory machine-readable medium of any one or more of examples 8-12, wherein the machine-readable instructions are to cause one or more of the at least one processor circuit to determine a current simulated steering wheel angle value based on the steering wheel torque value and a road wheel speed, and after determining that the current simulated steering wheel angle value is not greater than or equal to a previous simulated steering wheel angle value, set the current input target simulated steering wheel angle value equal to a simulated hands-off steering wheel angle value corresponding to the road wheel returning to a straight path of travel.

Example 14 includes the at least one non-transitory machine-readable medium of any one or more of examples 8-13, wherein the machine-readable instructions are to cause one or more of the at least one processor circuit to determine that the steering wheel torque value exceeds the threshold value in a first direction, the first direction opposite a second direction in which a previous steering wheel torque was applied to the spring-to-center steering wheel.

Example 15 includes a vehicle comprising a spring-to-center steering shaft having a portion statically fixed to a structure, the structure to resist rotation of the portion of the spring-to-center steering shaft, a spring-to-center steering wheel coupled to an end of the spring-to-center steering shaft, the spring-to-center steering wheel rotationally restricted by a torsional rigidity of the spring-to-center steering shaft, and a controller to after a threshold value is satisfied by a steering wheel torque value corresponding to a torque applied to the spring-to-center steering wheel, determine an output target steering wheel angle value based on a blending of a current input target simulated steering wheel angle value and a previous input target simulated steering wheel angle value, and control a road wheel actuator to turn a road wheel based on the output target steering wheel angle value.

Example 16 includes the vehicle of example 15, further including at least one of a shaft torque sensor or a load cell coupled to the spring-to-center steering shaft, the at least one of the shaft torque sensor or the load cell to generate a signal based on the torque transferred from the spring-to-center steering wheel to the spring-to-center steering shaft, the signal corresponding to the steering wheel torque value.

Example 17 includes the vehicle of example 15 and/or example 16, further including a geared angle sensor coupled to the spring-to-center steering shaft, the steering wheel torque value based on a twist angle of the spring-to-center steering shaft measured by the geared angle sensor, the twist angle of the spring-to-center steering shaft based on the torque produced via the spring-to-center steering wheel.

Example 18 includes the vehicle of any one or more of examples 15-17, wherein the controller is to determine a current simulated steering wheel angle value based on the steering wheel torque value and a road wheel speed, and after determining that the current simulated steering wheel angle value is greater than or equal to a previous simulated steering wheel angle value, set the current input target simulated steering wheel angle value equal to the current simulated steering wheel angle value.

Example 19 includes the vehicle of any one or more of examples 15-18, wherein the controller is to determine a current simulated steering wheel angle value based on the steering wheel torque value and a road wheel speed, and after determining that the current simulated steering wheel angle value is not greater than or equal to a previous simulated steering wheel angle value, set the current input target simulated steering wheel angle value equal to a simulated hands-off steering wheel angle value corresponding to the road wheel returning to a straight path of travel.

Example 20 includes the vehicle of any one or more of examples 15-19, wherein the controller is to determine that the steering wheel torque value exceeds the threshold value in a first direction, the first direction opposite a second direction in which a previous steering wheel torque was applied to the spring-to-center steering wheel.

Example 21 includes a steer-by-wire system comprising a spring-to-center steering shaft having a portion statically fixed to a structure, the structure to resist rotation of the portion of the spring-to-center steering shaft, a spring-to-center steering wheel coupled to an end of the spring-to-center steering shaft, the spring-to-center steering wheel rotationally restricted by a torsional rigidity of the spring-to-center steering shaft, and a torque sensor to measure a torque associated with the spring-to-center steering shaft, the torque based on a force applied to the spring-to-center steering wheel.

Example 22 includes the steer-by-wire system of example 21, wherein the torque sensor includes at least one of a load cell, a strain gauge, an encoder, or a geared angle sensor.

Example 23 includes the steer-by-wire system of example 21 and/or example 22, wherein the torque sensor is coupled to a fixed shaft portion of the spring-to-center steering shaft.

Example 24 includes the steer-by-wire system of any one or more of examples 21-23, wherein the structure is a torque arm, the torque sensor being a cantilever load cell that receives the torque from the torque arm.

Example 25 includes the steer-by-wire system of any one or more of examples 21-24, including a controller to control a road wheel actuator to turn a road wheel based on the torque.

From the foregoing, it will be appreciated that example systems, apparatus, articles of manufacture, and methods have been disclosed that implement SBW systems with spring-to-center steering wheel control of a vehicle. Disclosed systems, apparatus, articles of manufacture, and methods increase the efficiency of using SBW controller circuitry in a vehicle by controlling steering of the vehicle based on a spring-to-center steering wheel. Such use of the spring-to-center steering wheel reduces or eliminates the need to synchronize a rotational position of the steering wheel to an angle of the road wheels before full control is handed over to a driver from a driver-assistance mode in which the steering wheel may be parked at center. Disclosed systems, apparatus, articles of manufacture, and methods are accordingly directed to one or more improvement(s) in the operation of a machine such as a SBW ECU or other electronic and/or mechanical device.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. A steer-by-wire system comprising:
interface circuitry to obtain a steering wheel torque value corresponding to a torque applied to a spring-to-center steering wheel;
machine-readable instructions; and
at least one processor circuit to be programmed by the machine-readable instructions to at least:
after the steering wheel torque value satisfies a threshold value, determine an output target steering wheel angle value based on a blending of a current input target simulated steering wheel angle value and a previous input target simulated steering wheel angle value; and
control a road wheel actuator to turn a road wheel based on the output target steering wheel angle value.

2. The steer-by-wire system of claim 1, wherein the spring-to-center steering wheel is coupled to an end of a spring-to-center steering shaft in a vehicle, the spring-to-center steering shaft having a portion statically fixed to a structure, the structure to prevent rotation of the portion of the spring-to-center steering shaft, the spring-to-center steering wheel rotationally restricted by a torsional rigidity of the spring-to-center steering shaft.

3. The steer-by-wire system of claim 1, wherein the interface circuitry is to obtain the steering wheel torque value based on at least one of a shaft torque sensor or a load cell, the at least one of the shaft torque sensor or the load cell to sense the torque transferred from the spring-to-center steering wheel to a spring-to-center steering shaft.

4. The steer-by-wire system of claim 1, wherein the steering wheel torque value is based on a geared angle sensor coupled to a spring-to-center steering shaft.

5. The steer-by-wire system of claim 1, wherein one or more of the at least one processor circuit is to:
determine a current simulated steering wheel angle value based on the steering wheel torque value and a road wheel speed; and
after determining that the current simulated steering wheel angle value is greater than or equal to a previous simulated steering wheel angle value, set the current input target simulated steering wheel angle value equal to the current simulated steering wheel angle value.

6. The steer-by-wire system of claim 1, wherein one or more of the at least one processor circuit is to:
determine a current simulated steering wheel angle value based on the steering wheel torque value and a road wheel speed; and
after determining that the current simulated steering wheel angle value is not greater than or equal to a previous simulated steering wheel angle value, set the current input target simulated steering wheel angle value equal to a simulated hands-off steering wheel angle value corresponding to the road wheel returning to a straight path of travel.

7. The steer-by-wire system of claim 1, wherein one or more of the at least one processor circuit is to determine that the steering wheel torque value exceeds the threshold value in a first direction, the first direction opposite a second direction in which a previous steering wheel torque value was applied to the spring-to-center steering wheel.

8. At least one non-transitory machine-readable medium comprising machine-readable instructions to cause at least one processor circuit to at least:
access a steering wheel torque value corresponding to a torque applied to a spring-to-center steering wheel coupled to a spring-to-center steering shaft;
after the steering wheel torque value satisfies a threshold value, determine an output target steering wheel angle value based on a blending of a current input target simulated steering wheel angle value and a previous input target simulated steering wheel angle value; and
control a road wheel actuator to turn a road wheel based on the output target steering wheel angle value.

9. The at least one non-transitory machine-readable medium of claim 8, wherein the steering wheel torque value is based on a torsional rigidity of the spring-to-center steering shaft.

10. The at least one non-transitory machine-readable medium of claim 8, wherein the steering wheel torque value is based on a signal from at least one of a shaft torque sensor or a load cell, the signal corresponding to the torque transferred from the spring-to-center steering wheel to the spring-to-center steering shaft.

11. The at least one non-transitory machine-readable medium of claim 8, wherein the steering wheel torque value is based on a geared angle sensor coupled to the spring-to-center steering shaft.

12. The at least one non-transitory machine-readable medium of claim 8, wherein the machine-readable instructions are to cause one or more of the at least one processor circuit to:
determine a current simulated steering wheel angle value based on the steering wheel torque value and a road wheel speed; and
after determining that the current simulated steering wheel angle value is greater than or equal to a previous simulated steering wheel angle value, set the current input target simulated steering wheel angle value equal to the current simulated steering wheel angle value.

13. The at least one non-transitory machine-readable medium of claim 8, wherein the machine-readable instructions are to cause one or more of the at least one processor circuit to:
determine a current simulated steering wheel angle value based on the steering wheel torque value and a road wheel speed; and
after determining that the current simulated steering wheel angle value is not greater than or equal to a previous simulated steering wheel angle value, set the current input target simulated steering wheel angle value equal to a simulated hands-off steering wheel angle value corresponding to the road wheel returning to a straight path of travel.

14. The at least one non-transitory machine-readable medium of claim 8, wherein the machine-readable instructions are to cause one or more of the at least one processor circuit to determine that the steering wheel torque value exceeds the threshold value in a first direction, the first direction opposite a second direction in which a previous steering wheel torque was applied to the spring-to-center steering wheel.

15. A vehicle comprising:
a spring-to-center steering shaft having a portion statically fixed to a structure, the structure to resist rotation of the portion of the spring-to-center steering shaft;
a spring-to-center steering wheel coupled to an end of the spring-to-center steering shaft, the spring-to-center steering wheel rotationally restricted by a torsional rigidity of the spring-to-center steering shaft; and
a controller to:
after a threshold value is satisfied by a steering wheel torque value corresponding to a torque applied to the spring-to-center steering wheel, determine an output target steering wheel angle value based on a blending of a current input target simulated steering wheel angle value and a previous input target simulated steering wheel angle value; and
control a road wheel actuator to turn a road wheel based on the output target steering wheel angle value.

16. The vehicle of claim 15, further including at least one of a shaft torque sensor or a load cell coupled to the spring-to-center steering shaft, the at least one of the shaft torque sensor or the load cell to generate a signal based on the torque transferred from the spring-to-center steering wheel to the spring-to-center steering shaft, the signal corresponding to the steering wheel torque value.

17. The vehicle of claim 15, further including a geared angle sensor coupled to the spring-to-center steering shaft, the steering wheel torque value based on a twist angle of the spring-to-center steering shaft measured by the geared angle sensor, the twist angle of the spring-to-center steering shaft based on the torque produced via the spring-to-center steering wheel.

18. The vehicle of claim 15, wherein the controller is to:
determine a current simulated steering wheel angle value based on the steering wheel torque value and a road wheel speed; and
after determining that the current simulated steering wheel angle value is greater than or equal to a previous simulated steering wheel angle value, set the current input target simulated steering wheel angle value equal to the current simulated steering wheel angle value.

19. The vehicle of claim 15, wherein the controller is to:
determine a current simulated steering wheel angle value based on the steering wheel torque value and a road wheel speed; and
after determining that the current simulated steering wheel angle value is not greater than or equal to a previous simulated steering wheel angle value, set the current input target simulated steering wheel angle value equal to a simulated hands-off steering wheel angle value corresponding to the road wheel returning to a straight path of travel.

20. The vehicle of claim 15, wherein the controller is to determine that the steering wheel torque value exceeds the threshold value in a first direction, the first direction opposite a second direction in which a previous steering wheel torque was applied to the spring-to-center steering wheel.

21.-25. (canceled)
